(19) United States
(12) Patent Application Publication
(10) Pub. No.: US 2020/0258407 A1
(43) Pub. Date: Aug. 13, 2020

(54) VIDEO LAB BOOK ENVIRONMENT

(71) Applicant: My JoVE Corporation, Cambridge, MA (US)

(72) Inventors: Richard P. MEDEIROS, Lynn, MA (US); Dipesh Mukesh NAVANI, Ashland, MA (US); Justin J. CHERNY, Melrose, MA (US); Moshe PRITSKER, Melrose, MA (US)

(21) Appl. No.: 16/272,657

(22) Filed: Feb. 11, 2019

(51) Int. Cl. G09B 5/02; G06F 17/24; G06F 3/0483; G06F 17/22

(52) U.S. Cl. CPC G09B 5/02; G06F 17/2211; G06F 3/0483; G06F 17/24

(57) ABSTRACT

A video lab book environment provides online lab materials. The lab materials include video content. A student may access the lab materials remotely via a computing device. An instructor version enables an instructor to organize lab materials, modify lab materials and interact with students. An instructor may generate quizzes that may be taken online by students and automatically graded. Lab reports may be completed and submitted online. An instructor may provide grade reports online for students. A plagiarism checker may check with any portion of the lab reports have been plagiarized.

### BACKGROUND

Science courses, such as those in biology, chemistry or physics, typically include classroom instruction supplemented by laboratory experiments. The laboratory experiments may require that a student follow a prescribed procedure for performing the experiments. The experiments may involve the use of materials and laboratory equipment. In most instances, the students produce lab reports that capture the results of performing the experiments, including certain quantitative data. The lab reports may also require the students to submit written answers to questions or to summarize findings. Traditionally, lab reports have been submitted and written paper form.

### SUMMARY

In accordance with an aspect of an exemplary embodiment, a method is performed by a processor of a computing device. In this method, a user interface element is transmitted for display as part of a user interface for a video lab book. The user interface element is for modifying a lab of the video lab book. An indication of the user interface has been activated is received, and at least one modification of the video lab book is received. The lab is updated to include the modification, and information regarding the updated lab is transmitted for display.

The modification may include the adding or deleting of a step from a lab procedure for the lab. An additional user interface element may be provided for adding or deleting a step from the lab procedure. Another type of modification may be to modify a step of the lab procedure. An additional user interface element may be transmitted responsive to activation of the user interface element for modifying the step of the lab procedure. Alternatively, the modification may be one of modifying material used in the lab or modifying an amount of a material used in the lab. Responsive to activation of user interface element, another user interface may be transmitted from modifying the material used in the lab or modifying the amount of material used in the lab. The modification may, instead, entail adding, deleting and/or modifying notes regarding the lab. Another user interface element may be transmitted for the adding, deleting and/or modifying the notes regarding the lab responsive to activation to the user interface element.

This method may be performed by a server, and the transmitting of the user interface element and the transmitting of the information may be to a client.

Instructions for performing this method may be stored on a non-transitory computer-readable storage medium. These instructions may be executed by a processor of a computing device to perform the method.

In accordance with another aspect of an exemplary embodiment, a method is performed by a processor of a computing device. In this method, a lab report is received in a video lab book environment. The lab report is analyzed to identify any possible instances of plagiarism. If the analyzing indicates that there is at least one possible instance of plagiarism, information is output indicating that there is at least one identified possible instance of plagiarism. The analyzing may comprise comparing content in the lab report to other sources to identify any possible plagiarized portion of the lab report. Output may be generated that identifies the possible plagiarized portion of the lab report. If the analysis indicates that there are no identified possible instances of plagiarism in the lab report, an output may be generated indicating that there are no identified possible instances of plagiarism in the lab report.

Instructions for performing this method may be stored on a non-transitory computer-readable storage medium for execution on a processor of a computing device.

In accordance with an additional aspect of an exemplary embodiment, a method is performed by a processor of a computing device such that a user interface for a video lab book environment is transmitted, where the user interface enables the setting or modification of online rights for instructors for a course in the video lab manual environment. A setting or a modification of a selected one of the online rights of a given one of the instructors of the course where the setting or modification is received via the user interface. In response to receiving the setting or the modification, the selected online right of the given instructor is updated to reflect the received setting or modification. The received setting or modification may relate, for instance, to one of a right to send electronic messages to students, a right to add content for online test, a right to add lab content online, a right to add online resources or a right to add online to add an additional instructor.

### BRIEF DESCRIPTION OF THE DRAWINGS

FIG. 1 shows an illustrative user interface for an instructors version of a video lab book environment.

FIG. 2A illustrates an example of a display of student information in various sections in an exemplary embodiment.

FIG. 2B illustrates an additional portion of the user interface of FIG. 2A that shows information for all the sections associated with an instructor.

FIG. 3A shows an example of user interface that results from selection an option to shuffle and edit labs in the video lab manual in an exemplary embodiment.

FIG. 3B shows an additional portion of the user interface of FIG. 3A where inactive labs are displayed.

FIG. 4A illustrates an example of a user interface depicting instructor resources in an exemplary embodiment.

FIG. 4B shows the user interface of FIG. 4A including additional instructor resources.

FIG. 5 illustrates an illustrative user interface relating to quizzes in an exemplary embodiment.

FIG. 6 depicts an illustrative user interface relating to lab reports and grades associated with lab reports in an exemplary embodiment.

FIG. 7A shows an illustrative user interface for building quizzes in an exemplary embodiment.

FIG. 7B illustrates additional portion of the user interface of FIG. 7A showing additional questions.

FIG. 7C shows an example wherein the instructor has requested the adding of an additional question via the user interface of FIG. 7A.

FIG. 8 depicts an illustrative user interface in which grade information for students in sections of the course are shown and are editable in an exemplary embodiment.

FIG. 9 shows an illustrative user interface for setting or modifying the online rights of instructors for a given course in an exemplary embodiment.

FIG. 10A shows an illustrative user interface for resources, including instructor resources that may be accessible by instructors online in an exemplary embodiment.

FIG. 10B shows an illustrative user interface for student resources that may be accessed by students online.

FIG. 11 shows an illustrative user interface through which announcements may be accessed in an exemplary embodiment.

FIG. 12A depicts an illustrative user interface in which a procedure for a lab is depicted and is editable in an exemplary embodiment.

FIG. 12B illustrates an instance in which an additional user interface element is provided to add a note to the procedure for a lab in an exemplary embodiment.

FIG. 12C shows an illustrative user interface in which a list of materials for a lab is displayed and is editable in an exemplary embodiment.

FIG. 12D illustrates an exemplary user interface in which the instructors guide is depicted and editable.

FIG. 12E is a flowchart illustrating steps that may be performed to edit a lab in an exemplary embodiment.

FIG. 13 depicts a illustrative distributed environment that may be suitable for practicing exemplary embodiments.

FIG. 14 depicts an example of a computing system that may be used in exemplary embodiments.

FIG. 15 is a flowchart illustrating the steps that may be performed to identify possible plagiarism in a lab report in an exemplary embodiment.

FIG. 16A depicts an illustrative initial login screen that may be provided for a student version of the video lab book environment.

FIG. 16B illustrates a follow on the screen that may be displayed after a user as provided the information in the initial screen of FIG. 16A.

FIG. 17 depicts an initial illustrative user interface that may be provided to a student after completing login to the video lab book environment in an exemplary embodiment.

FIG. 18 depicts a illustrative user interface showing labs in an exemplary embodiment.

FIG. 19 depicts an example of contents of a particular lab in an exemplary embodiment.

FIG. 20A depicts the quizzes portion of the video lab book environment that is available to a student in an exemplary embodiment.

FIG. 20B depicts an illustrative quiz in an exemplary embodiment.

FIG. 20C depicts a graded version of the quiz of FIG. 20B.

FIG. 21 depicts an example of an illustrative lab procedure available to a student in an exemplary embodiment.

FIG. 22A depicts an illustrative user interface to which a student may enter a lab report in an exemplary embodiment.

FIG. 22B illustrates an instance in which a lab has been selected and the student is prompted to drag the file associated with the lab report for uploading the lab report in exemplary embodiment.

FIG. 22C illustrates a subsequent user interface element that is shown after the lab report has been uploaded in an exemplary embodiment.

FIG. 23 depicts grade information for a student in an exemplary embodiment.

### DETAILED DESCRIPTION

Exemplary embodiments herein relate to a video lab book environment. The video lab book environment provides lab materials online and includes video content that explains the procedures and concepts for each lab. The video lab book environment may be accessible via a computing device. Thus, students may access the video labs remotely using a computing device that may communicate with a server computing device that holds content for the video lab book environment.

In some exemplary embodiments, the server is accessed by using a web browser on the client computing device. The student enters a uniform resource locator (URL) for the video lab book environment via the web browser. The server returns web content to the student's client computing device. The web content may include web pages like those described below. The web pages may include active components and static content as well as dynamic content. The web pages may be encoded in markup languages such as the Hypertext Markup Language (HTML) or the Extensible Markup Language (XML). The provision of the web pages may be under the control of the executable programming language code run at the server computing device. The server computing device may store the web content, programming code and other data in an associated storage.

Although only a single client and a single server have been discussed herein, a single server may serve multiple client computing devices for multiple parties, and there may be multiple servers.

The video lab book environment provides a set of first version for instructors and a second version for students. The instructor version enables an instructor to build a lab, modify content of a lab and provide access to the labs to students. The instructor version also enables the instructor to develop online quizzes, grade such quizzes and keep track of students' grades during the given term of the associated course. Instructors are also able to provide resources to students and to provide announcements and other information to students. Still further, the instructor version enables a professor or other instructor to set and modify the online rights of the assistant instructors, such as teaching assistants. The video lab book environment may also provide identification of possible plagiarism in lab reports submitted by students.

The student version of the lab book enables students to review lab materials and provides instructions for performing a lab. Moreover, the student version enables the user to generate and submit a lab report after completing a lab. A student may gain access to his grades, may be provided information and may take quizzes via the video lab book environment. The quizzes may be graded, and the student may review the quizzes to obtain information as to correct wrong answers.

The discussion below will first focus on the instructor version, then on a distributed environment for practicing an exemplary embodiment and lastly, on the student version.

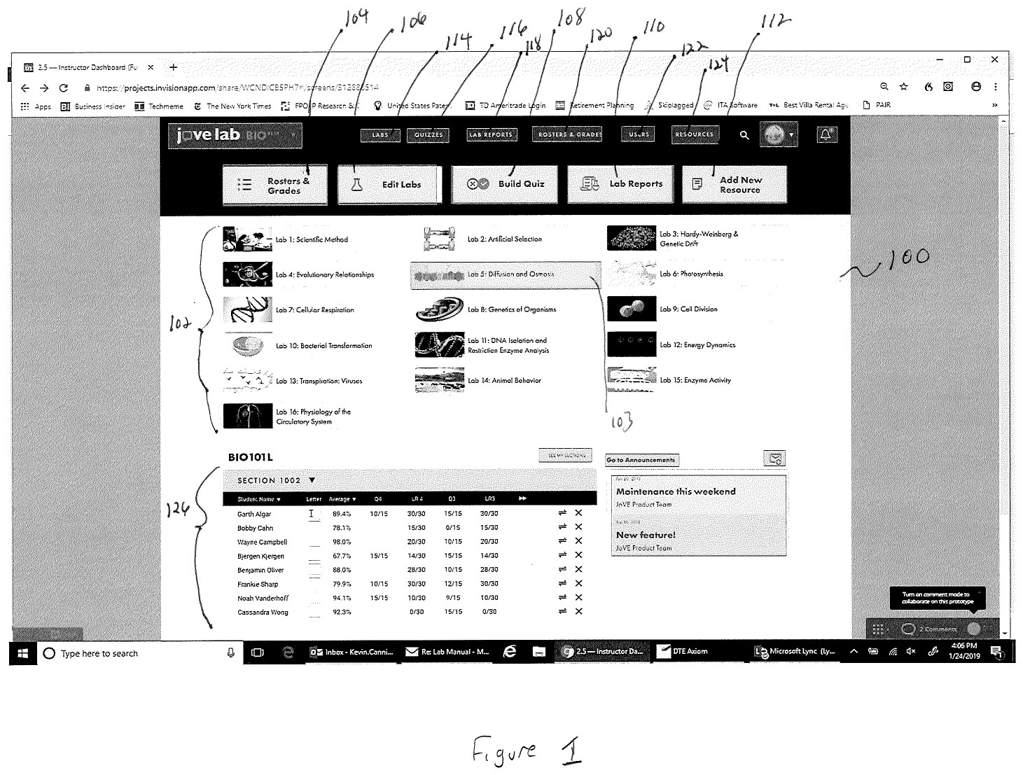

FIG. 1 depicts an example user interface 100 for the instructor version of the video lab book environment. This user interface may be part of a web page retrieved by an instructor after logging onto the video lab book environment. This may entail opening a web browser and directing the web browser to a specified URL. The instructor may be prompted to login to obtain the initial user interface 100 shown in FIG. 1. Those skilled in the art will appreciate that the video lab book environment need not be accessible via a web browser but rather may be realized as a distributed application running on a local network in some exemplary embodiments.

As shown in FIG. 1, in the illustrative user interface 100, the video labs 102 that are part of the course are identified and displayed. In the example depicted in FIG. 1, there are sixteen labs numbered from one to sixteen. It is worth noting that the lab number five (see 103) is shaded indicating that that lab is inactive such that the lab will not be used. The video lab book environment may be preloaded with lab content for certain courses. This lab content of the labs 102 may be included or excluded at the desire of the instructor. Each of the tabs may be selected to show more content about the selected lab as will be discussed below.

The illustrative user interface 100 includes a section listing 126 for section 1002 of the course that lists the students in the section and provides grade information for the students. Often a course is divided into multiple sections containing a subset of the students. Thus, for example, student “Garth Algar” is shown as being in section 1002 and having a current grade of 89.4 percent.

The illustrative user interface 100 includes a number of user interface elements 104, 106, 108, 110 and 112 that may be activated to gain access to related content in the video lab book environment. In the example shown in FIG. 1, these user interface elements 104, 106, 108, 110 and 112 may be buttons that may be selected using an input device, such as a mouse or a keyboard, to activate the user interface elements. User interface element 104 enables access to roster and grade information for the course. User interface element 106 enables the editing of the editing of lab content. User interface element 108 enables the building or modifying of a quiz. User interface element 110 provides information relating to lab reports, and user interface element 112 enables the adding of a new online resource.

In the example user interface 100 shown in FIG. 1, there is a second row of buttons 114, 116, 118, 120, 122 and 124 positioned at the top of the page. Button 114 enables access to lab information, whereas button 116 enables access to quiz information. Button 118 enables access to lab reports, and button 120 enables access to information regarding rosters and grades. Button 122 enables access to information regarding users in the form of instructors and button 124 enables access to online resources.

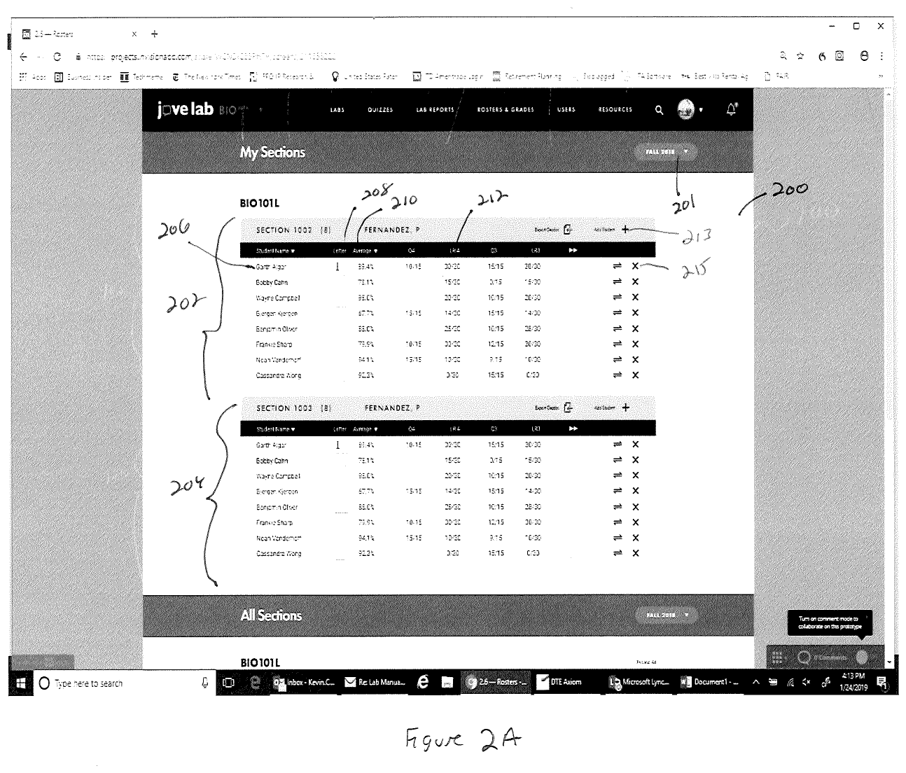

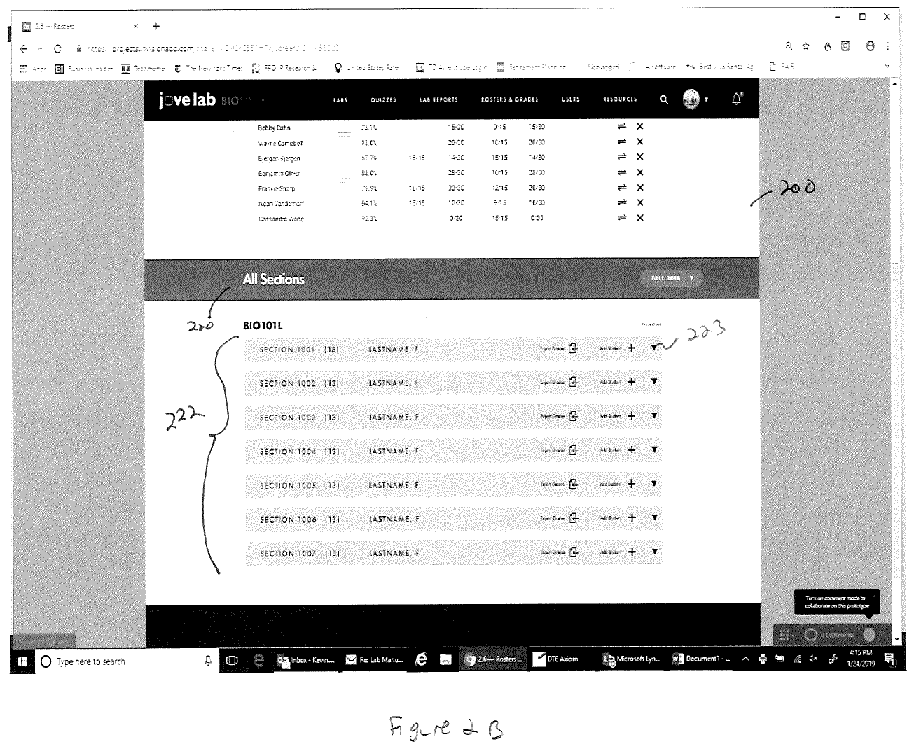

FIG. 2A depicts an illustrative user interface 200 that is part of a web page that may be displayed when an instructor selects the rosters and grades button 104. As shown, there is a roster for the sections that are being handled by the instructor. In the illustrative case shown in FIG. 2A there is a roster 202 for section 1002 and a roster 204 for a section 1003. A dropdown list 201 identifies the term for which the information is provided. Each roster 202 and 204 contains information for students. For example, row 206 contains information for student “Garth Algar.” The information includes a text box for specification of a letter grade 208 or a field 210 that shows a numerical average. Information regarding a particular test 212 and the associated grade may also be provided. The information contained in the section rosters 202 and 204 may be retrieved from databases provided for the video lab book environment, as will be discussed in more detail below. An icon 213 may be selected to add a student to a roster, and an icon 215 may be selected to remove a student from a roster.

FIG. 2B shows an additional portion of the illustrative user interface 200 of FIG. 2A. Rosters and grades may also be available for all sections 200 for the associated course. In the example shown in FIG. 2B, the rosters for sections 1001 through 1007 are shown in collapsed form. These rosters may be expanded by selecting user interface element 223 in the respective section element.

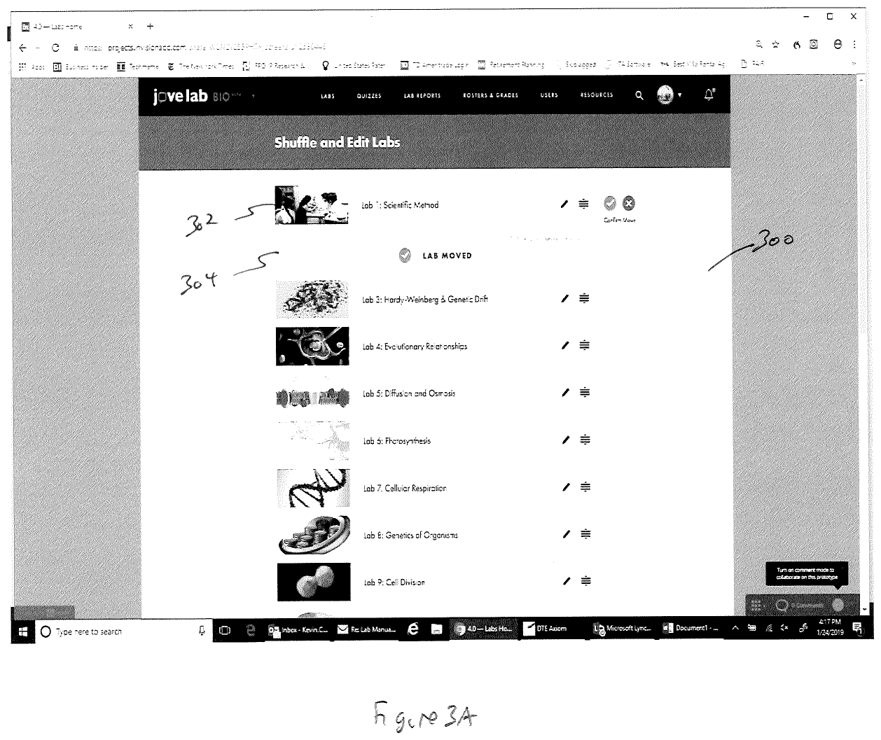

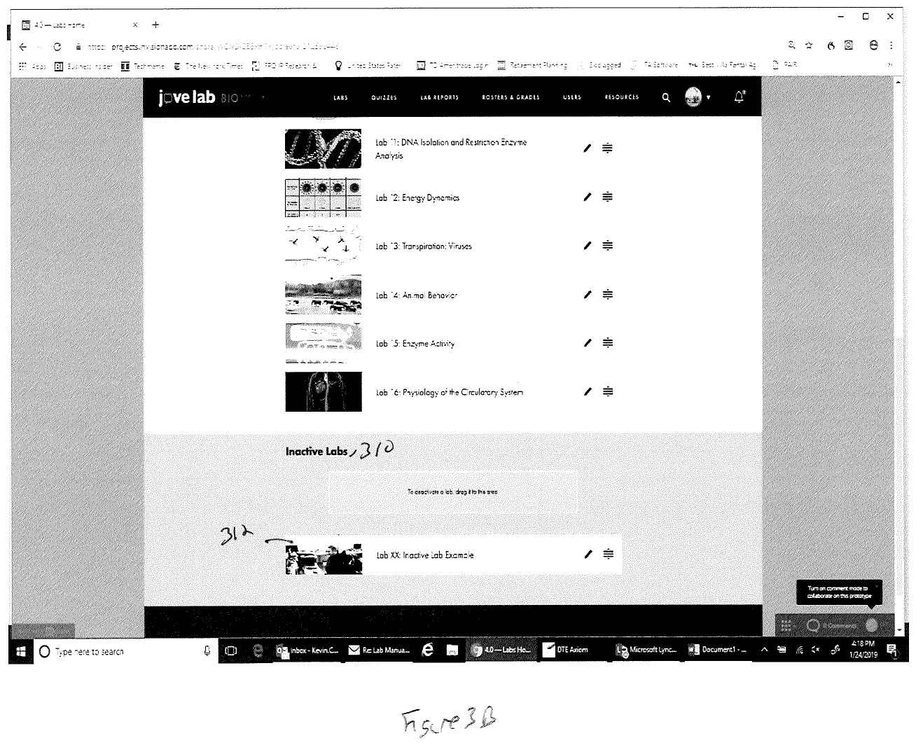

Selection of the edit labs button 106 may result in the display of a user interface 300, such as shown in FIG. 3A. Elements, such as element 302 for each of the labs may be displayed. The elements are displayed in order, and these elements may be selected to edit or move the labs. In the example shown in FIG. 3A, Lab 2 has been moved as evidenced by the user interface element 304 containing the text “Lab Moved.” As shown in FIG. 3B, the user interface element associated with the lab may be dragged into the inactive lab section 310 to make lab inactive and not a current portion of the curriculum for the course. In the example shown in FIG. 3B, a lab has been dragged to the inactive labs area 310 and has an associated user interface element 312.

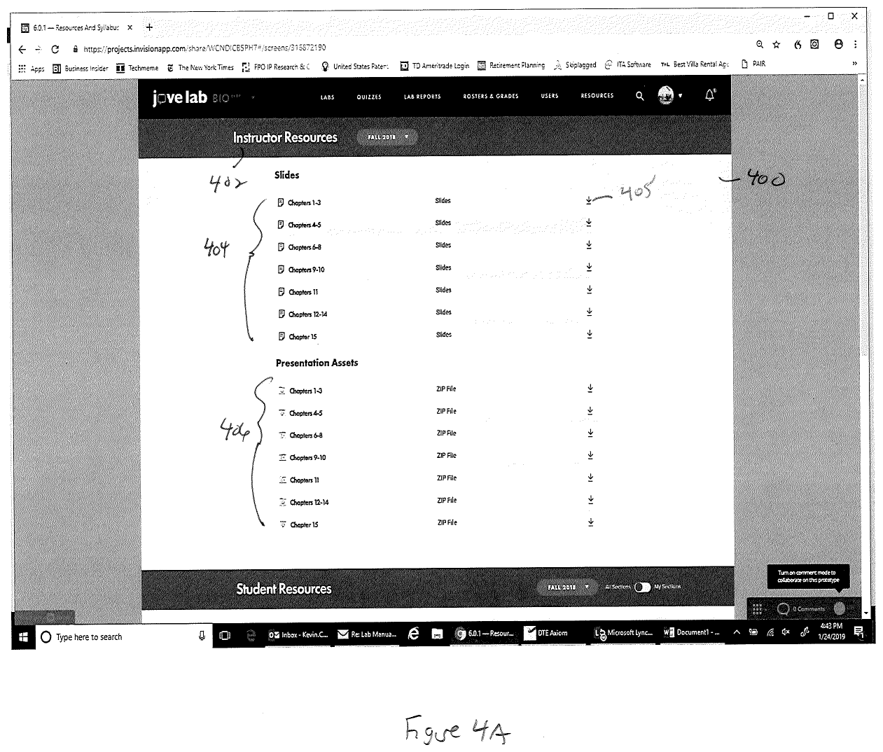

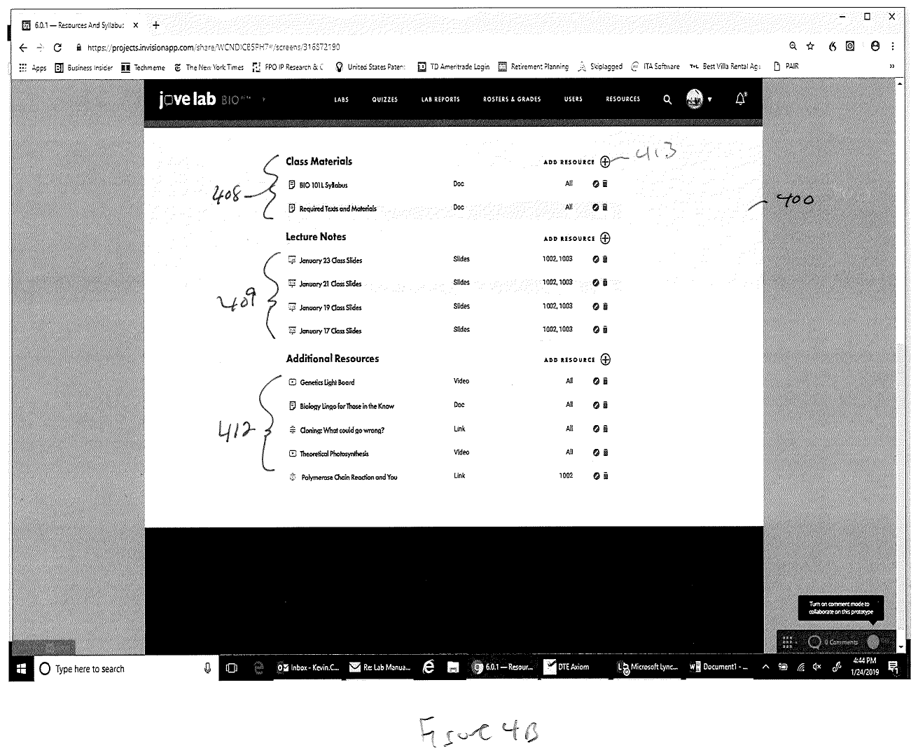

FIG. 4A depicts an illustrative user interface 400 that is displayed when the user selects the add new resources button 112. The user interface 400 depicts instructor resources 402. in the illustrative case, this includes slides and presentation assets. The instructor can add or remove these resources using this user interface 400. Moreover, the instructor can select a download icon 405 to download an instructor resource. As shown in FIG. 4B, student resources may also be depicted in user interface 400. In the example shown in FIG. 4B, class materials 408 may be included as well as lecture notes 409 and additional resources 412. These student resources may be accessible by students as needed, whereas the instructor resources are provided for instructors of the courses, including teaching assistants or other associated instructors. The plus sign icon 413 may be selected to add a student resource to a particular category of student resource.

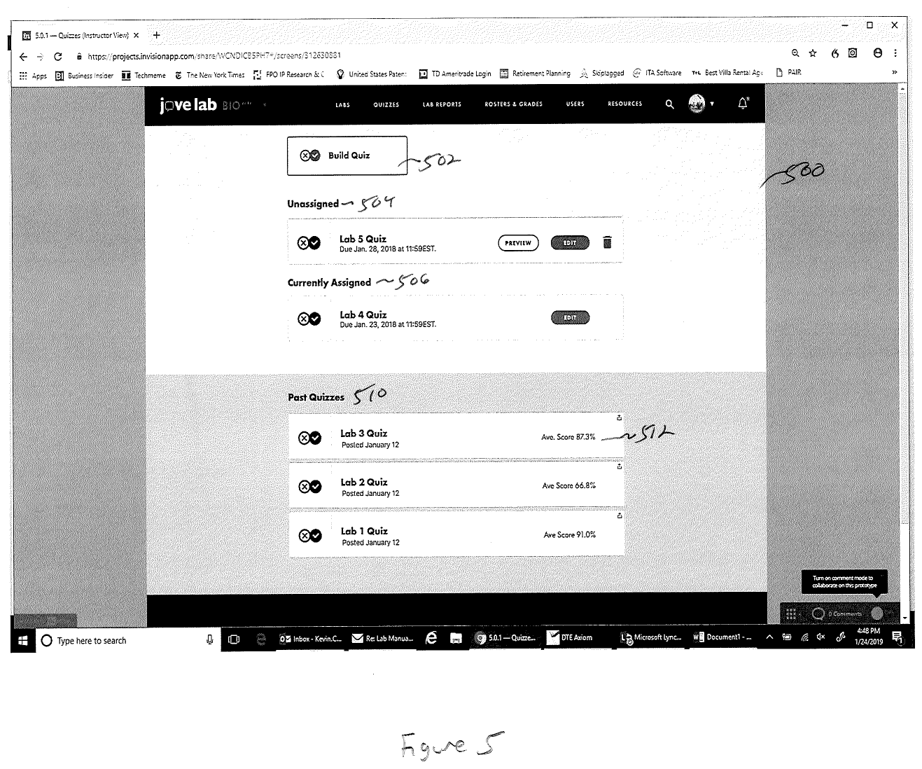

FIG. 5 depicts an illustrative user interface 500 provided in the video lab manual environment when an instructor selects the build quiz button 108. A build quiz button 502 is provided to build a new quiz. The video lab book environment will provide templates from which quizzes may be built, such as for multiple choice questions where content can be provided for the questions as well as the possible answers. This illustrative user interface shows unassigned quizzes 504, assigned quizzes 506 and past quizzes 510. The past quizzes, may include information such as the average score 512, for a quiz.

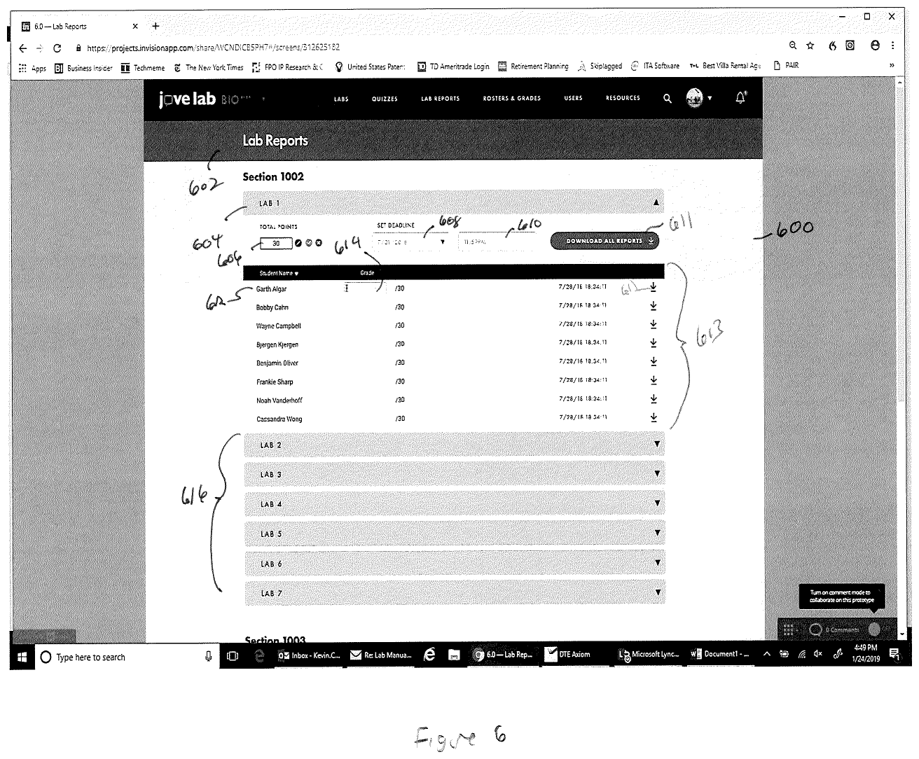

FIG. 6 depicts an illustrative user interface 600 that may be displayed when the lab reports button 110 is selected. The user interface 600 lists the various lab reports 602. In the example shown in FIG. 6, labs 2-7 are shown in collapsed form 616, whereas lab 1 604 is shown in expanded form. The instructor has the option of specifying the total number of points for the quiz by entering a value in the box 606. Box 608 enables the establishment of the date of a deadline for the lab report, and box 610 enables specification of a time in which the lab report is due. Button 611 enables the instructor to download all reports that have been uploaded by students. Element 613 lists a roster of the students that have uploaded lab reports and allows the instructor to download a particular lab report by selecting the download element 615. The instructor may assign a grade for a lab report by entering a value in box in 614 for the lab report.

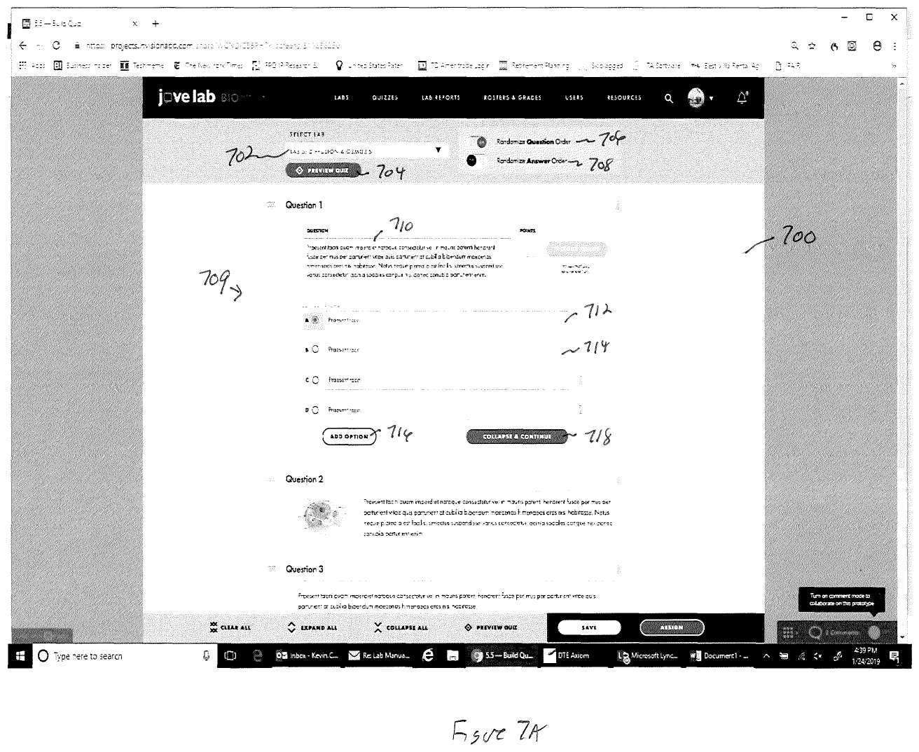

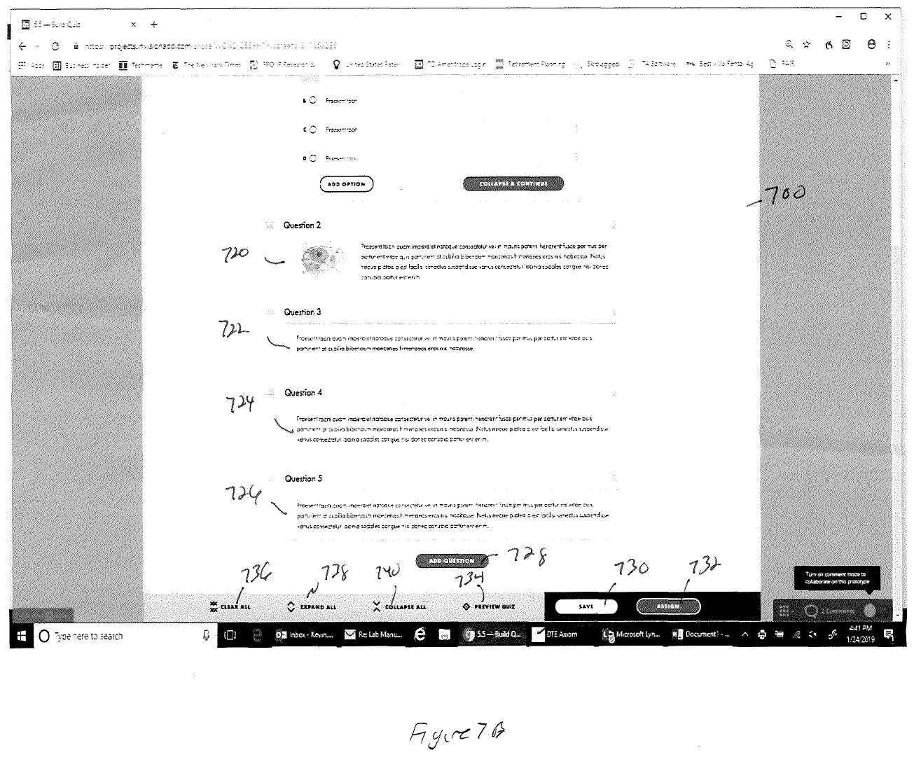

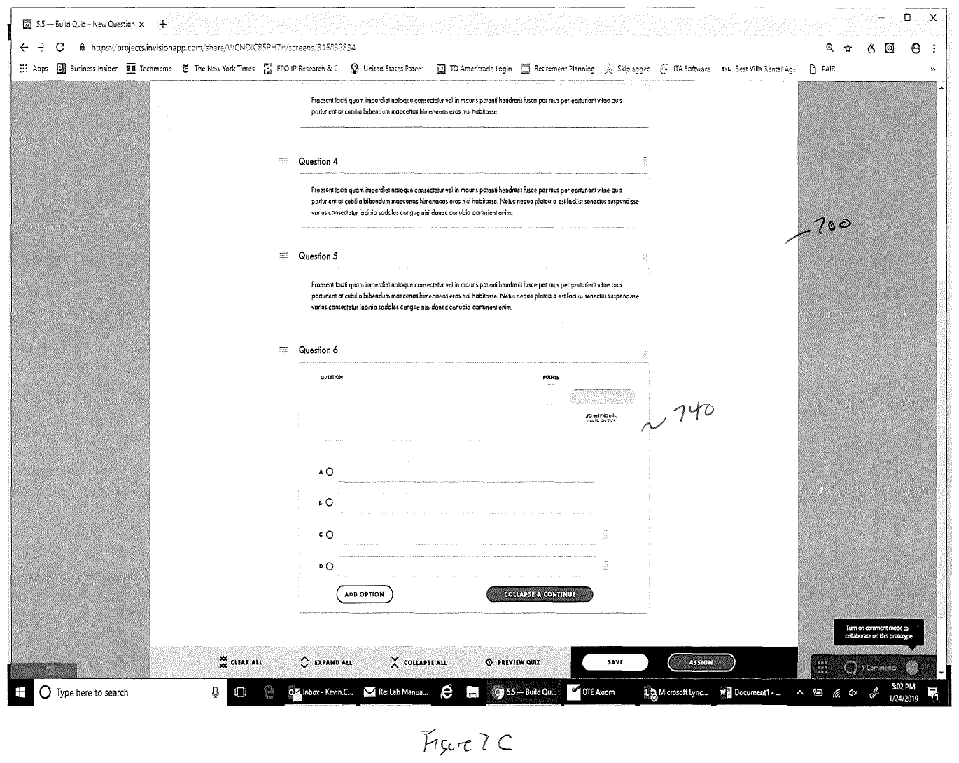

As mentioned above, the instructor has the ability to modify quizzes. FIG. 7A shows an example of an illustrative user interface 700 for modifying the quizzes. In dropdown list 702, the instructor may select a particular lab and then may activate button 704 to preview a quiz associated with the lab. Toggles 706 and 708 are provided to randomize the question order and randomize the answer order, respectively. The toggles 706 and 708 may be set to a first position to randomize or to a second position to not randomize. This allows the instructor to randomize the sequence of questions and/or the sequence of answers so that to prevent inadvertent patterns or relationships from being evident in the quiz. As shown in FIG. 7A, the user interface 700 includes question one is expanded form where the body of the question 710 may be displayed along with answers 712, 714 and the like. Each of the answer options may be provided by the instructor. By using button 716, an instructor may add an additional answer may be provided. The answer 712 is darkened to indicated that it is the correct answer. Once the question has been properly constructed, the instructor may activate the collapse and continue button 718 to proceed with the next question.

FIG. 7B shows an additional portion of the illustrative user interface 700 containing additional questions 720, 722, 724 and 726. Questions may be added by activating the add question button 728. A clear all option 736 is provided to clear all the questions and answers so as to begin anew. An expand all option 738 is provided for expanded all of the questions. Conversely, a collapse all option 740 is provided to collapse all the questions and answers. A preview quiz option 734 is provided to enable a preview of the quiz as constructed currently. Once the instructor is comfortable with the quiz or wishes to stop working on the quiz, the contents may be saved to storage by activating the save button 730. An assign button 732 assigns the quiz to students in a particular section or sections of the course.

As was mentioned above, questions may be added to a quiz. As shown in FIG. 7C, a new question, question 6, has been added. User interface element 740 is provided and has spaces for the text of questions and answers to be added by the instructor.

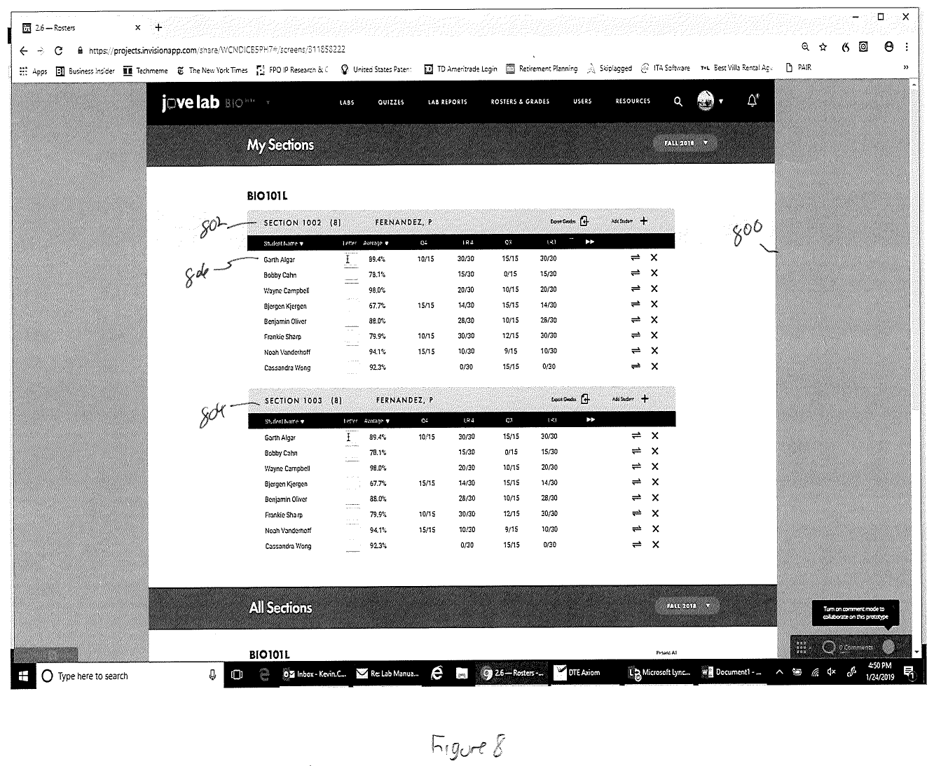

The instructor also has the option of selecting button 120 to (FIG. 1) to review the rosters and grades. FIG. 8 shows an example of an illustrative interface 800 where headers 802 and 804 are provided for respective sections 1002 and 1003. Each line, such as line 806, is associated with a particular student and includes grade information as well as the name of the student.

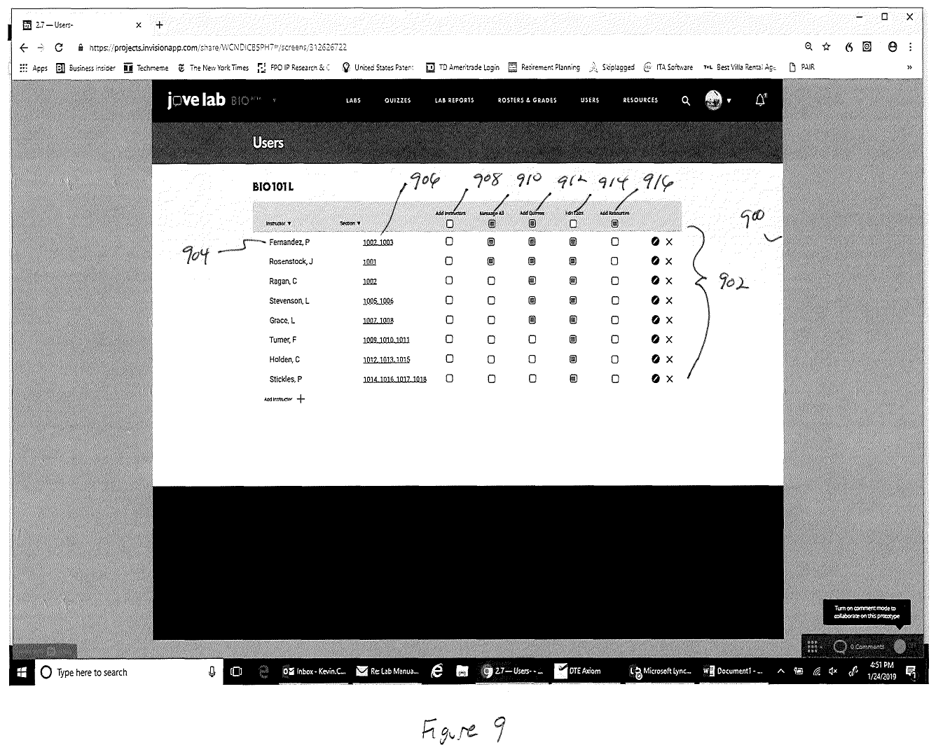

An instructor may select the users options 122 to display users of the instructor version of the video lab book environment. FIG. 9 shows an example of an illustrative user interface 900 for establishing the online rights of users, such as associated instructors, like teaching assistants. Often in collegiate environments, a professor has a number of teaching assistants that assist with teaching a class. As can be seen, the roster 902 lists each of the instructors and provides information 906 regarding what sections they teach and provides a number of check boxes 908, 910, 912, 914 and 916 relating to online rights for the associated instructor. The add instructors checkbox 908 determines whether a user is able to add an additional instructor to the roster or not. The message all checkbox 910 enables a user to send messages to all of the students and instructors. The add quizzes checkbox 912 determines whether a user is able to add quizzes for the course. The add labs checkbox 914 determines whether a user is able to add a lab amongst the online labs provided for a course. Still further, the add resources checkbox 916 is provided to enable a user to add resources or not.

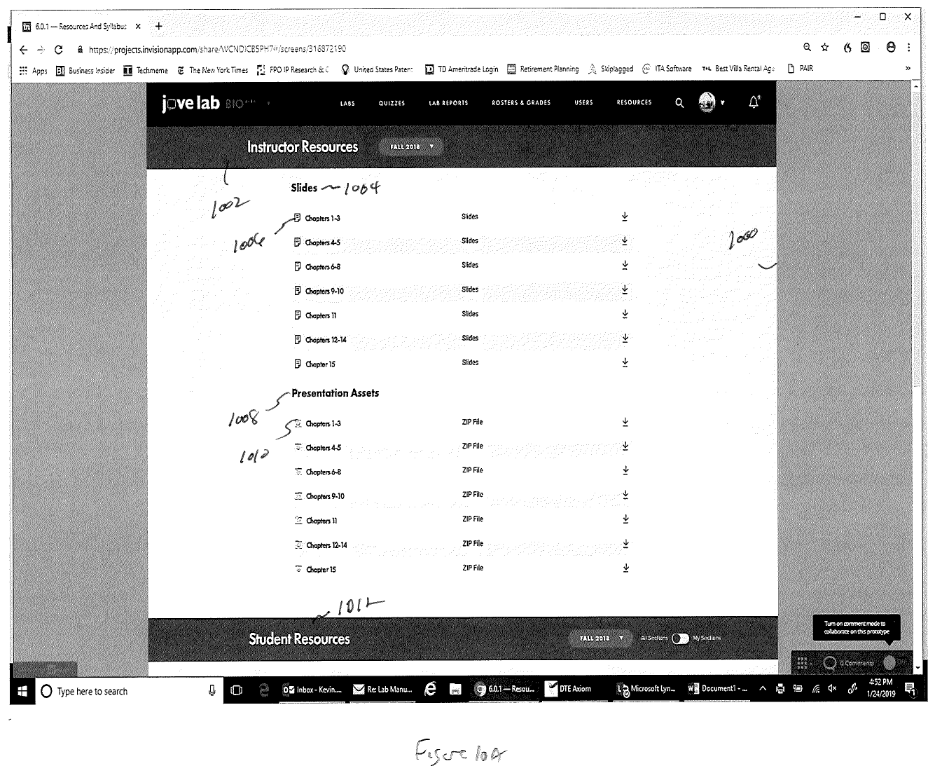

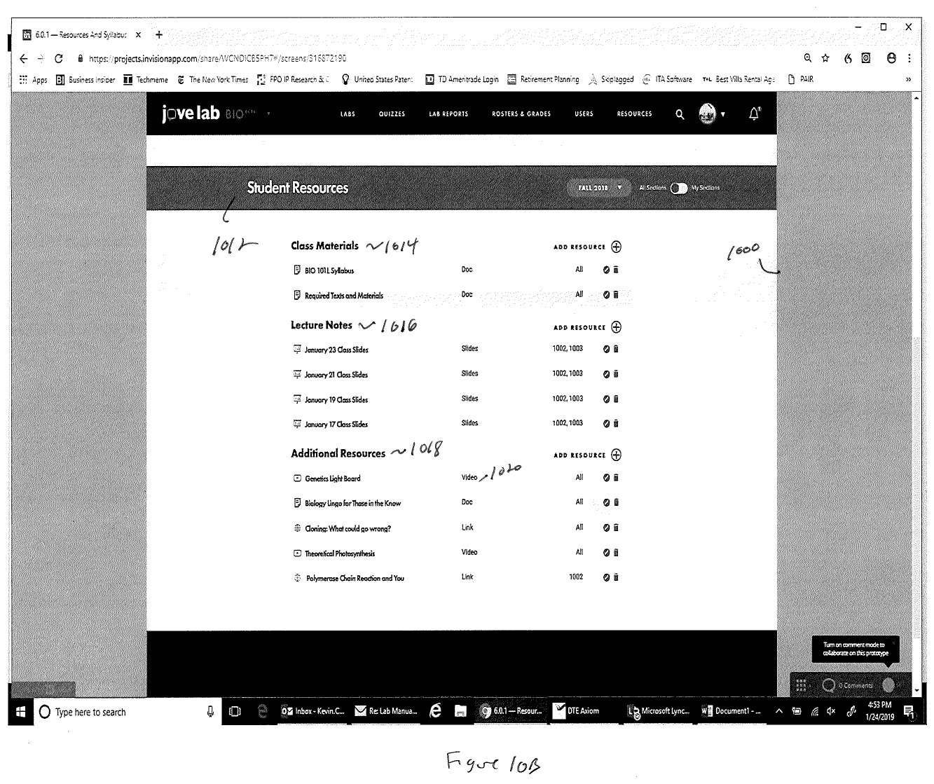

An instructor may gain access to the resources that are currently available by selecting the resources button 124. FIG. 10A shows an example of an illustrative user interface 1000 for showing the resources. The resources include instructor resources 1002 as well as student resources 1012. In this example, the instructor resources include slides 1004, such as slides 1006 for chapters one through three as well as presentation assets 1008, such those for chapters 1-3 1012.

FIG. 10B shows an example of some student resources 1012 in the illustrative user interface 1000. These include class materials 1014, lecture notes 1016 and additional resources 1018. The resources may include a designation, such as designation 1020, that specifies the type of information the resource is.

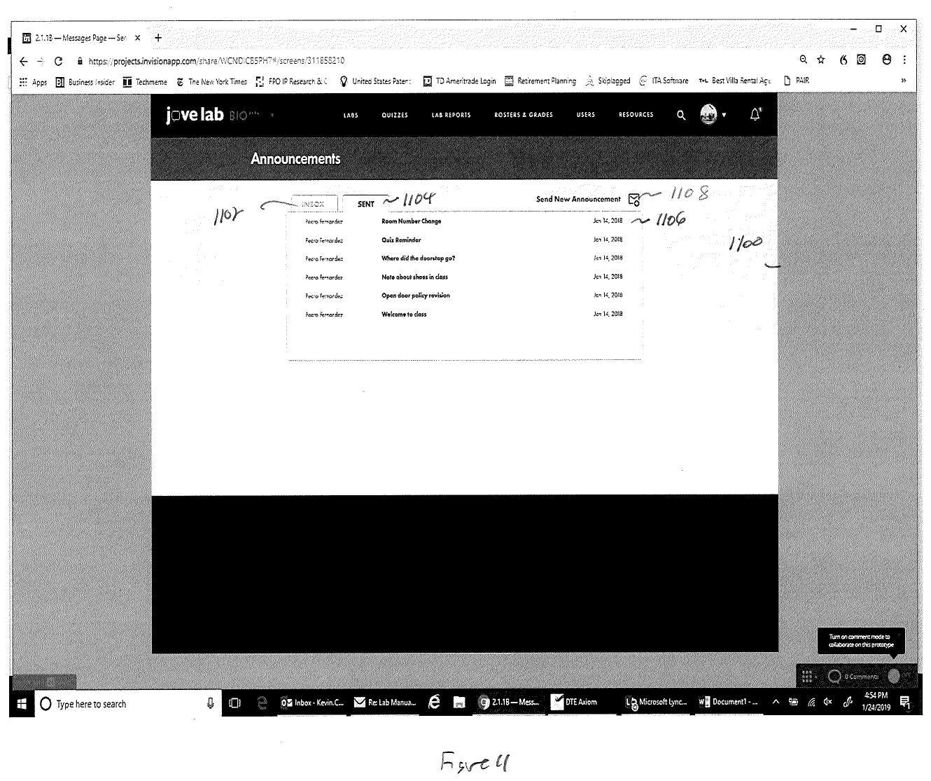

The instructor has the ability to look at received announcements as well as sent announcements as shown in FIG. 11. The illustrative user interface 1100 includes a tab 1102 for showing received announcements in an inbox as well as tab 1104 for showing announcements that were sent. Each row 1106 of the announcements may contain information such as, the sender, the topic and the date in which the announcement was sent. An instructor may send out an announcement to students and/or instructors by selecting send new announcement 108 and providing the content of the new announcement.

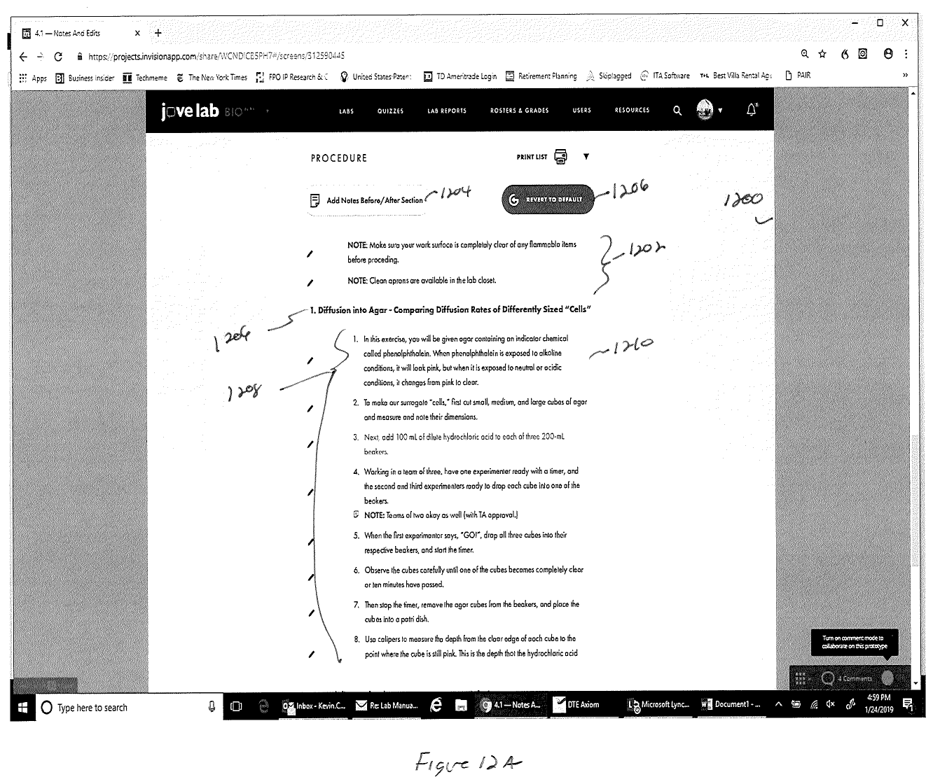

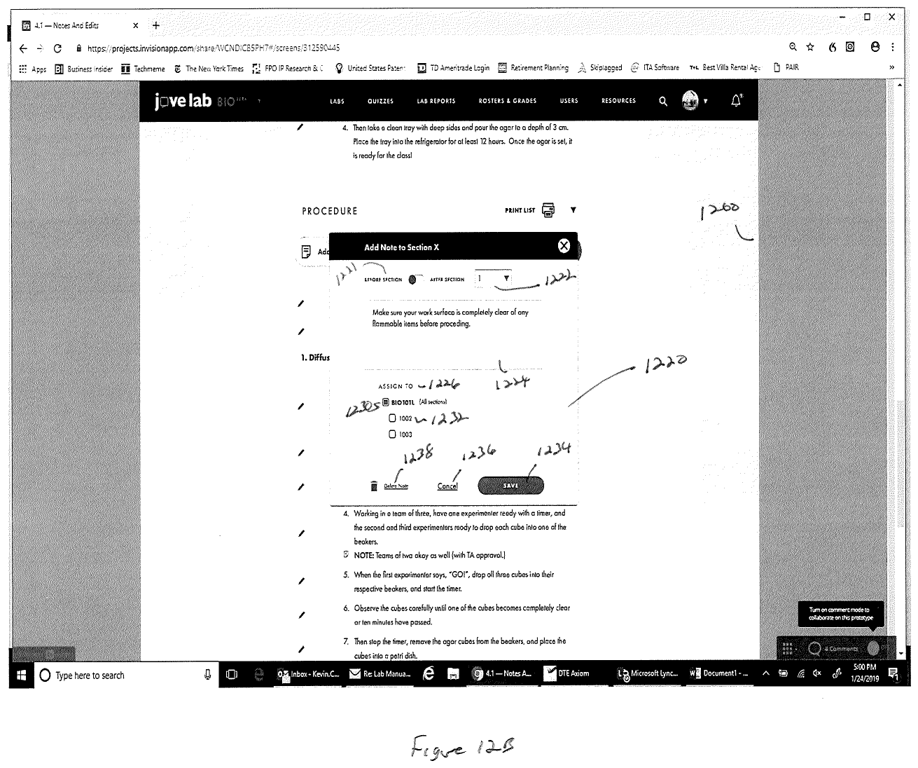

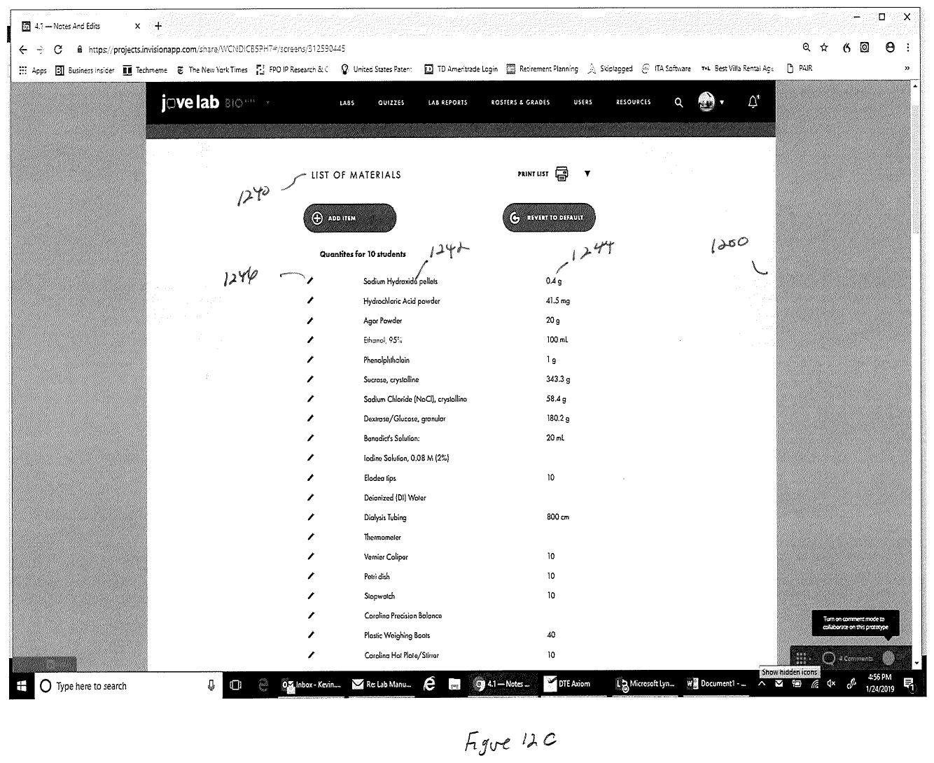

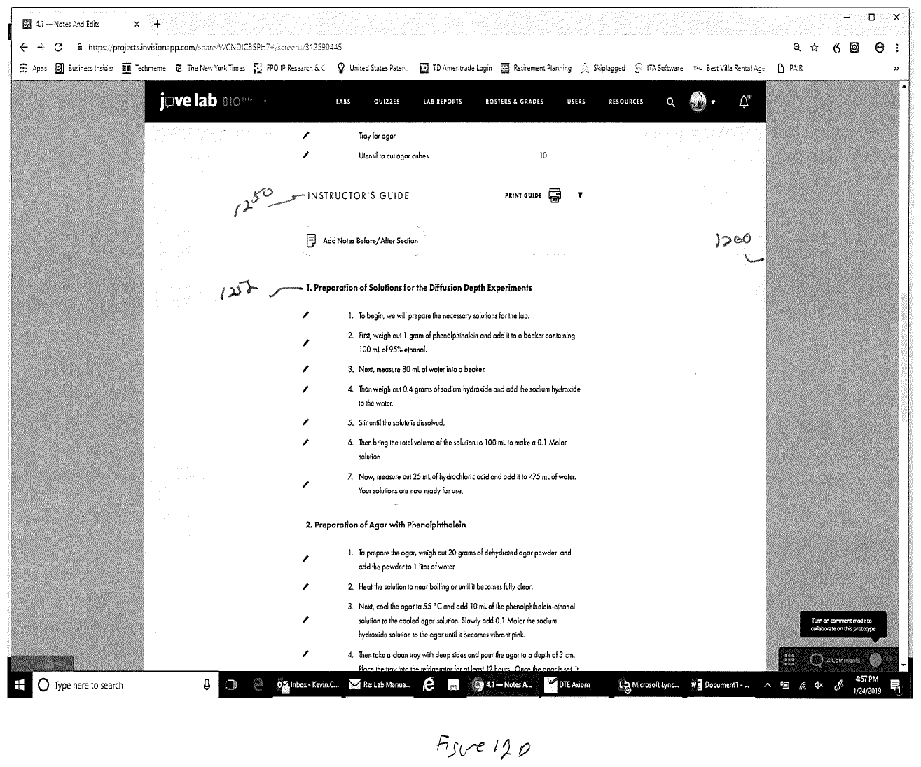

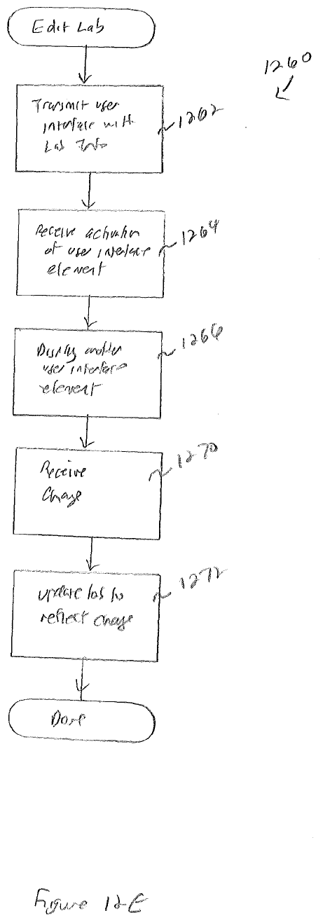

As was discussed above, the instructor may edit the labs, such as by collecting the edit labs button 106, by accessing the lab via the labs button 114 or by double clicking on a displayed lab element 102 (FIG. 1). FIG. 12A shows an example of a portion of a lab displayed in an illustrative user interface 1200. This portion of the lab relates to the procedure to be followed in the lab. A button 1204 is provided for adding notes before or after the section (i.e., the procedure section). This allows an instructor to add notes into the procedure. Example notes 1202 are shown in FIG. 12A. A button 1206 is provided to revert the lab back to a default format 1206. This provides the instructor with the option of undoing changes that are made to the lab to the original default form. As can be seen in FIG. 12A, the procedure lays out how to perform the lab. Steps, such as step 1206, are identified along with sub steps 1208 that includes a step, such as step 1210 explaining the process of organizing sequential order.

FIG. 12B shows an example where an instructor wishes to add a note. In that case, a user interface element 1220 is shown that is allows the instructor to add the note. The instructor is given the option to assign the note 1226 to all sections by selecting text box 1230 or by selecting a particular section, such as section 1002 by selecting checkbox 1232. An option 1238 is provided to delete a note, option 1236 is provided to cancel the adding of the note and button 1234 is provided to save the note.

FIG. 12B shows an additional portion of lab information that is visible by scrolling down the illustrative user interface 1200. This additional portion includes a list of materials 1240. Each row includes an identification of a material 1242 and a amount 1244. By selecting the icon 1246, the materials and/or the amount may be modified.

FIG. 12D shows a further portion of the lab that includes the instructor's guide 1250. The instructor's guide provides useful information to the instructor. In the example shown in FIG. 12D, section one 1252 deals with preparation of solutions for Diffusion Depth experiments. These components may be modified as needed.

FIG. 12E shows a flowchart 1260 for editing a lab. As was discussed above, a user interface may be transmitted with the lab information (step 1262). The user interface 1200 in FIGS. 12A-12D are examples of such user interfaces. A user interface element for editing a lab component may be received (step 1264). As was discussed relative to FIGS. 12A-12D, there are a number of user interface elements that may be activated to modify content of the lab. Another user interface element may be displayed in some instances (step 1266). For example, the user interface 1220 shown in FIG. 12B may be displayed when a user wishes to add a note. The changed information is received in step 1270. The lab is then updated to reflect this change in step 1272. The lab information is stored persistently in a database and the associated web pages may be updated in some embodiments.

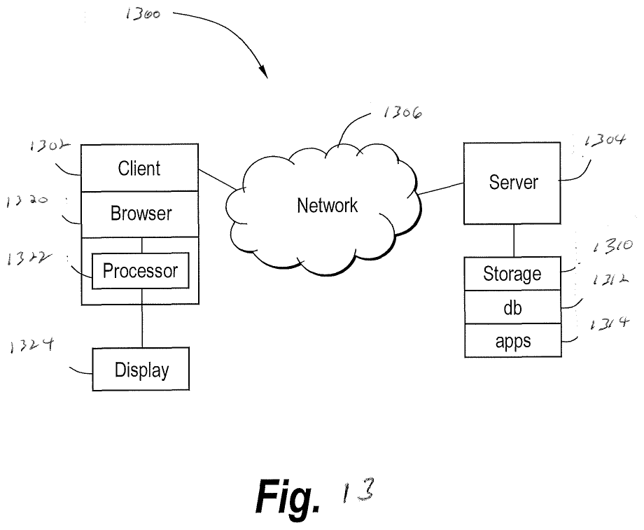

FIG. 13 shows an example of a distributed environment 1300 that is suitable for practicing an exemplary embodiment. In accordance with FIG. 13, a client 1302 communicates with a server 1304 over a network 1306. The client may be any of a number of types of computing devices, including but not limited to a desktop computer, a laptop computer, a tablet computer, a smartphone, or other computing device. A network 1306 may take various forms including a number of varieties of local area networks or wide area networks, such as the Internet. The server 1304 may be a dedicated server computing device or may be a server process running on a computing device. The server has access to a storage 1310. The storage may include a database 1312 in which the web pages, and data necessary for the video lab manual environment are provided. For example, information regarding courses, institutions, students, instructors, grades, content of labs, and the like may be stored in a relational database that are accessed as needed by the video lab book environment. For example, separate relational table may hold information regarding academic institution, course, section, student, labs, lab reports, resources, instructors, quizzes and the like.

The storage also may store or more application programs 1314 that are executable by the server 1304. These application programs include those that provide the video lab book environment. This may include scripting language content, programming language content, such as a Java, Javascript, Python, C, C++ or other programming languages and associated web content, such as web pages written in HTML or XML, for example.

The storage 1310 may include one or more devices and may be realized in a number of different forms. The storage 1310 may include optical storage and/or magnetic storage. The storage 1310 may include solid state storage, flash memory, read only memory, random access memory or the like. The storage may include non-transitory computer-readable storage medium for storing instructions for performing the functionality described herein.

The client computer 1302 may include a web browser 1320. The web browser 1320 may understand and be able to render markup language content, such as HTML and XML as well as Java, Javascript and the like. Moreover, the browser 1220 may be able to support dynamic content, such as found with Javascript and other technologies. The client computer 1302 includes at least one processor 1322 that may include a number of cores or may include multiple processing capabilities. The processor 1322 executes instructions for obtaining and sending information. The client 1302 may be located remotely from the server 1304. In an exemplary embodiment, the client 1302 accesses the Internet to communicate with a website. The server executes the instructions for providing the content for the video lab book environments to the client. Client 1302 may have access to a display device 1324 for displaying video content. It should be appreciated that the depiction of FIG. 13 is intended to be merely illustrative and not limiting of the claimed invention.

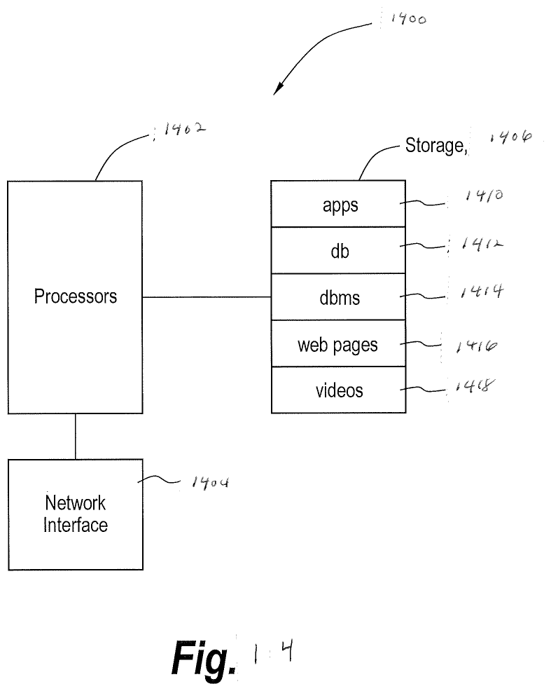

FIG. 14 shows an example of a server computing device 1400. The server computing device 1400 may include one or more processors 1402 for executing programs and other executable content. The server 1400 may include a network interface 1404 for interfacing with the network 1306. The storage 1406 may include applications 1410 as well as the database 1412, as discussed above. The database management system 1414 may be provided to manage access to and from the database. As was mentioned above, the storage may also include webpages 1416 for the video lab book environment as well as a video 1418.

Amongst the applications that may be executed by the server computer is one is part of the video lab book environment for checking whether there is plagiarism or not. In particular, a check can be made whether the content of a lab report is likely plagiarized. This may entail comparison with a known content, including that from related resources or even from other students.

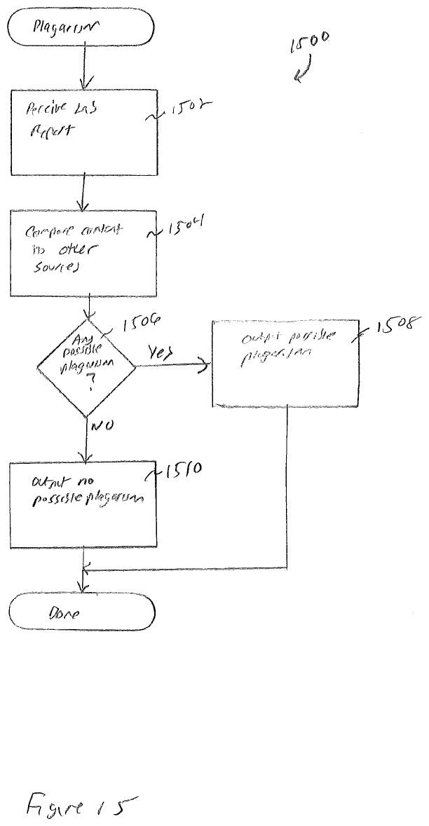

FIG. 15 shows a flowchart of the steps performed by this tool. Initially a lab report is received from a student (step 1502). As was discussed above, a student has the ability to upload a lab report to the video lab manual environment. The content of the lab report is then compared to other sources (step 1504). The comparison checks to see how much difference there is between the content of what is contained in the lab report and what is contained in the other sources. A check is then made whether there is any possible plagiarism (step 1506). There may be a threshold of similarity that is required before any portions that are similar between the received lab report and the other sources is identified as being possibly plagiarized. If there is sufficient similarity, an output is generated indicating possible plagiarism (step 1508). This output may take the form of simply a flag indicating that there is an issue or may still indicate how much similarity there is between the lab report and given source. Still further, the output may take the form of a report that highlights what portions of the lab report are deemed to be possibly plagiarized. Still further, the output may be sent to an instructor or to other school officials to indicate that there is a possible problem. In contrast, if there is no identified possible plagiarism as checked in step 1506, then an output may be generated indicating no possible plagiarism (step 1510). An alternative embodiments, no output is generated when there is no identified possible plagiarism.

The above discussion has focused on the instructor version of the video lab manual environment. As was mentioned above, there is also a student version that may be accessed by students of a course.

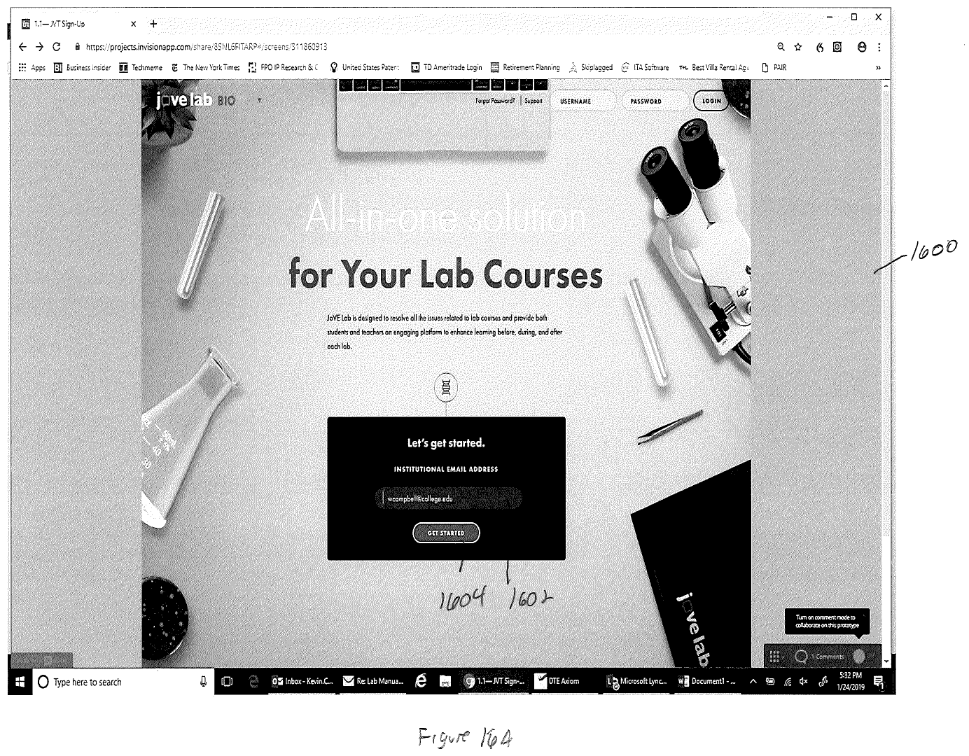

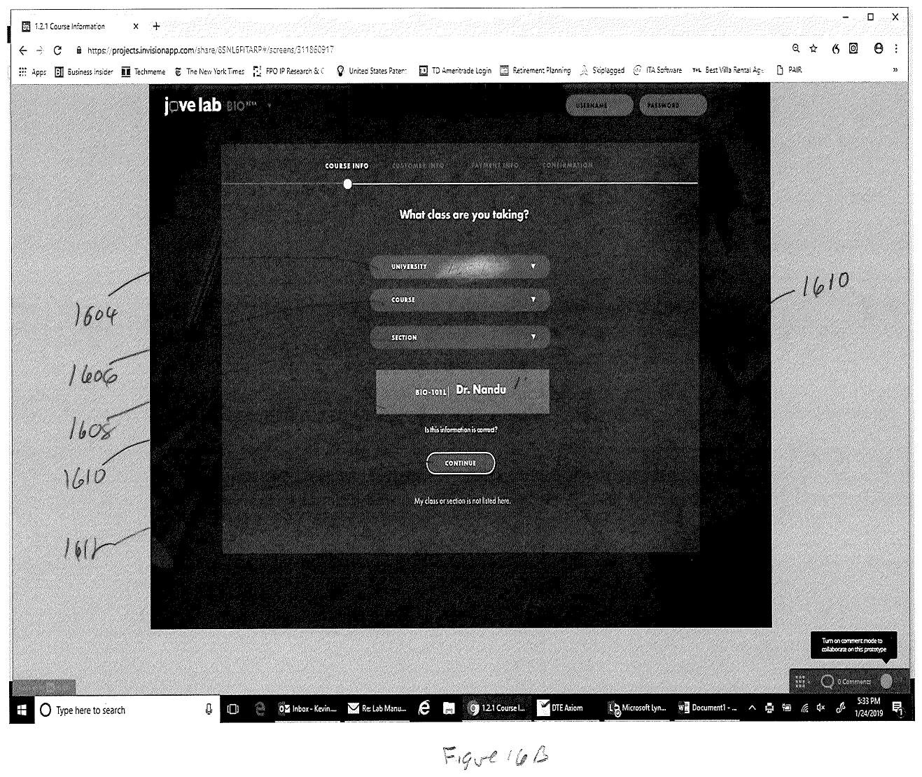

FIG. 16A shows and example of an initial screen 1600 that may be displayed to a student. The student is prompted to provide their institutional email address 1602 and then activate the get started button 1604. The institution email address identifies the academic institution as well as the student's identity. This screen is followed by a screen 1610 shown in FIG. 16B. Screen 1610 prompts the student for information to identify the university 1604, the course 1606, the section of the course 1608 by making selections from dropdown lists. Section 1610 identifies the identity of the course as well as the instructor. Once the requisite information is provided, a continue button 1612 may be activated.

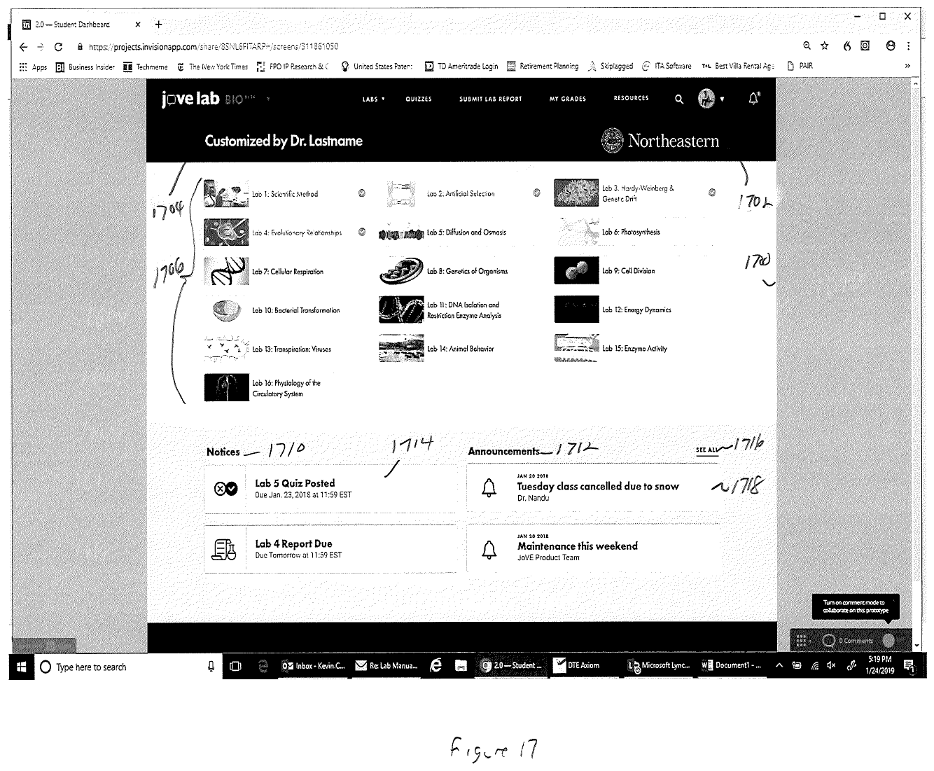

FIG. 17 shows an example of an initial user interface 1700 shown to a student after logging in by providing information on the screen 1600 and 1610 discussed above. The user interface 1700 may identify the instructor 1704 and well as the academic institution 1702. A list of labs 1706 may be provided. Labs that have been completed may be greyed and include a checkbox, whereas those that are still to be done are not greyed out and do not contain the checkbox. A notice in section 1710 may be provided. The example note 1714 specifies that a quiz has been posted and shown in FIG. 17 specifies the due date for the quiz. Announcement 1712 may be provided. Announcements 1718 is an example showing that the announcement indicates that the class has been canceled due to snow. “See all” option 1716 may be provided to see all the announcements or see all the notices.

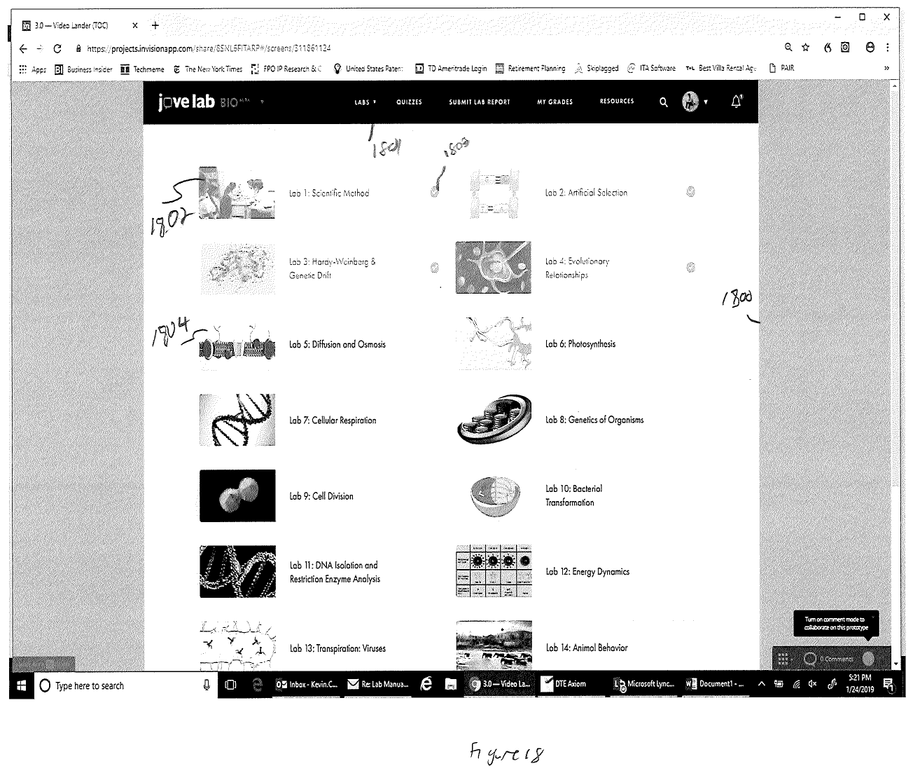

FIG. 18 shows the labs when a user selects the labs option 1801. As mentioned above, completed labs, such as Lab one 1802 are shown in greyed out form and have a checkbox 1803. The active labs, such as Lab five 1804, are not greyed out and do not include the checkbox.

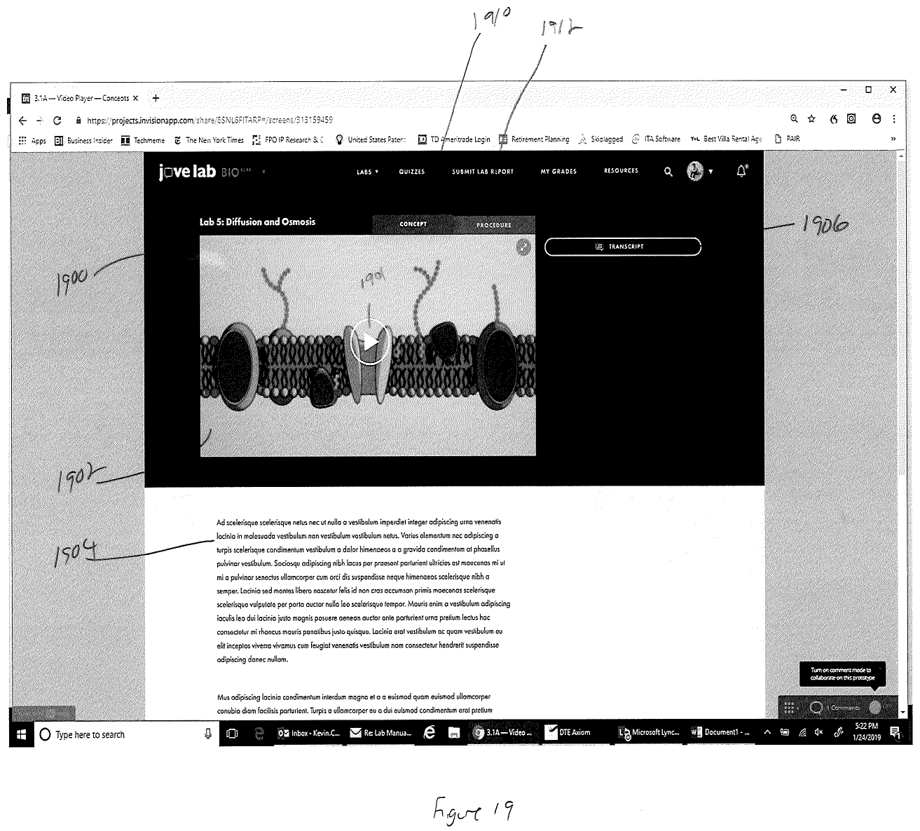

A user may open a lab by selecting the associated lab element. For example as shown in FIG. 19 if a user selects element 1804 in FIG. 8 for Lab five, the content of the lab becomes displayed. The lab may include video content 1900 that may be started and stopped using control 1901. Video content is displayed in video area 1902. Associated text 1904 may be also displayed. The user may select to see content relating to the concepts associated with the lab 1910 or may select to see information regarding the procedure 1912 for the lab.

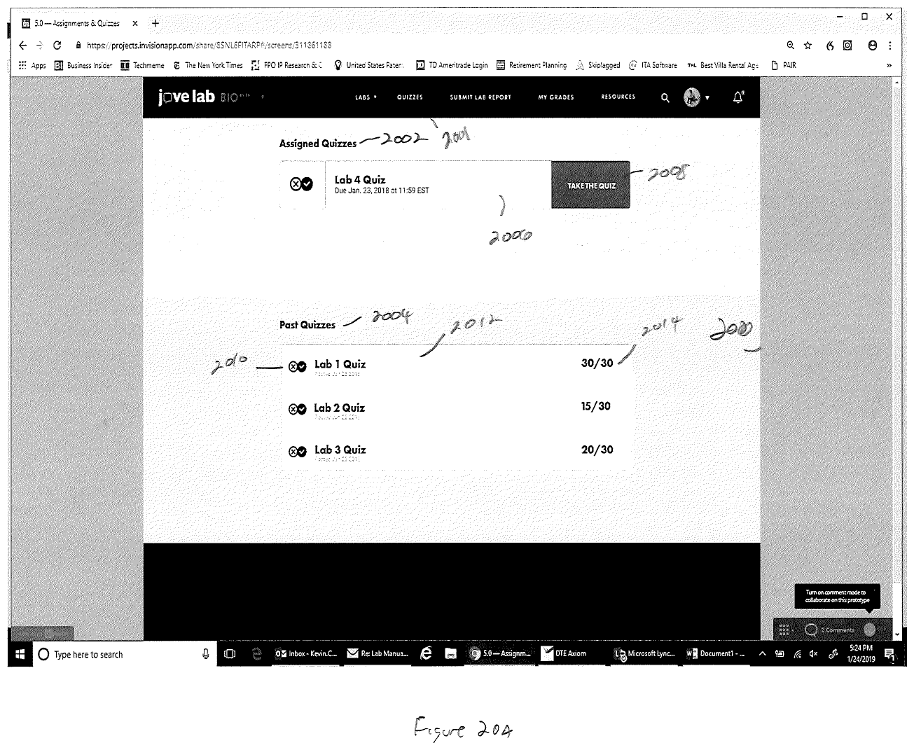

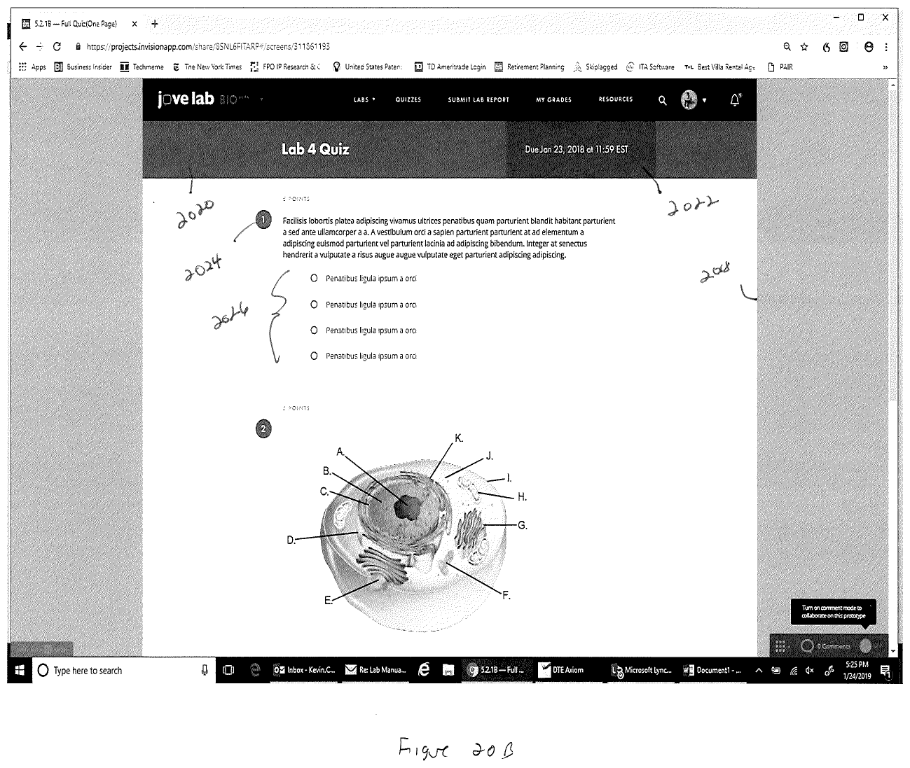

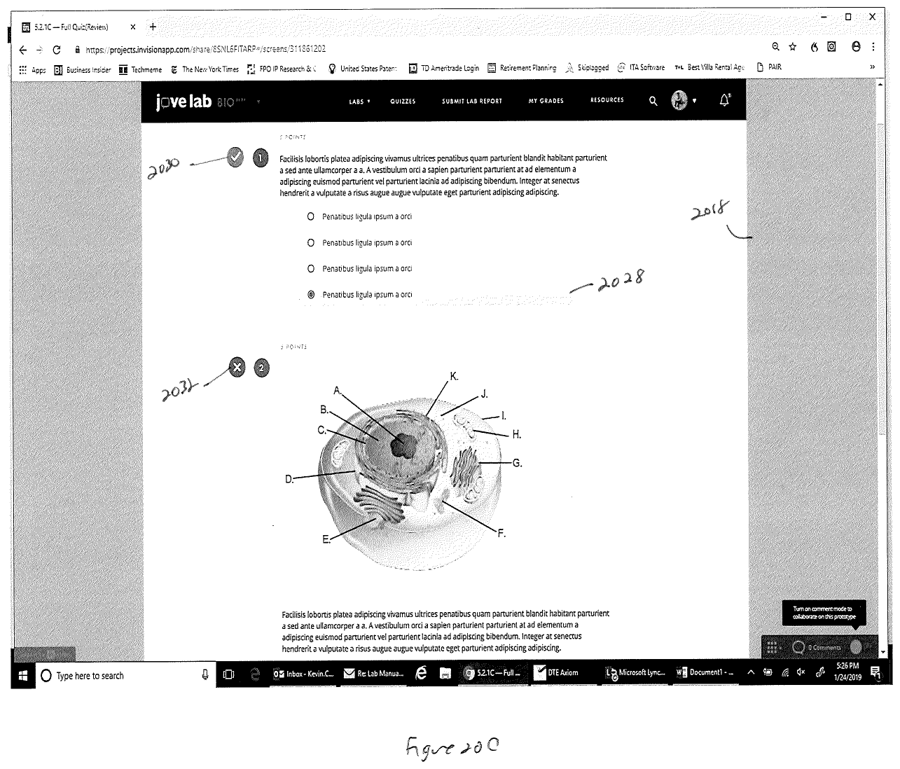

A student may access quiz information by selecting the quiz option 2001 as shown in FIG. 20A. The illustrative user interface 2000 includes a list of the assigned quizzes 2002 that have not been taken as well as past quizzes 2004. The assigned quizzes include, for example entry 2006 that identifies the quiz and the due date. If the student wishes to take the quiz, the student may activate the take the quiz button 2008. The past quizzes include a listing 2012 of the past quizzes. Each entry 2010 may include information such as the name of the quiz as well as the score 2014 that the student received on the quiz.

FIG. 20B shows an example of a quiz that may be displayed when the students selects the take the quiz button 2008. The contents of the Lab four quiz 2020 are shown in the illustrative user interface 2018. The due date 2022 is shown. The quiz includes a question 2024 and answers 2026. The student may select on one of the answers 2026 to complete answering the question 2024. After the student has completed the quiz, the student may request that the quiz be graded to yield the graded quiz such as shown in FIG. 20C. The illustrative user interface 2018 shows each of the questions and an indication of whether the question was answered properly or not. For example, question one includes a checkmark 2030 indicating that the proper answer was selected. The proper answer 2028 is highlighted. In contrast, question two includes an X mark 2032 indicating that the question was answered improperly.

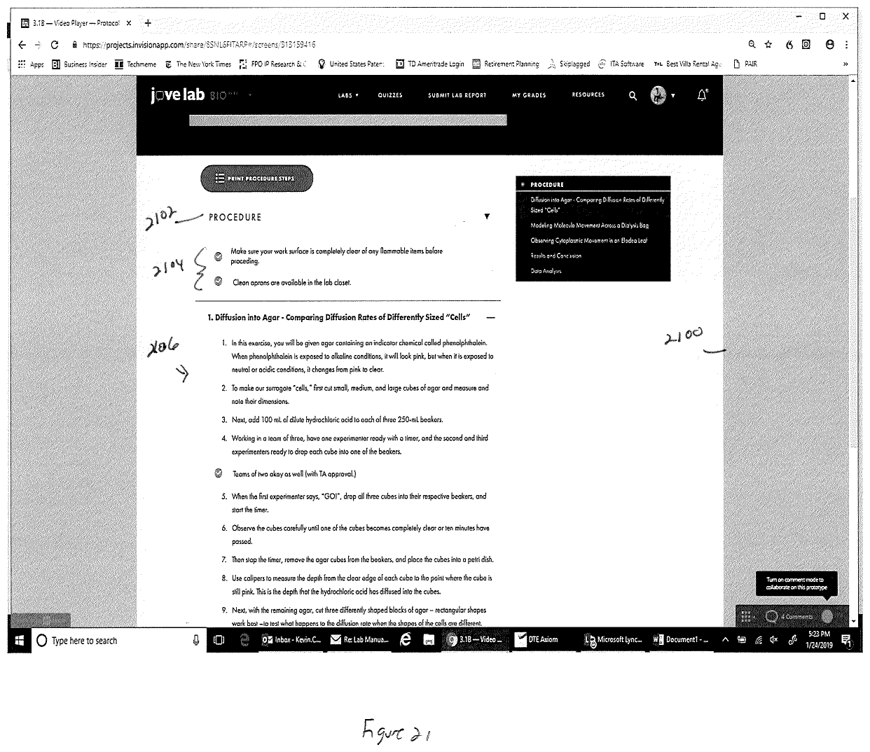

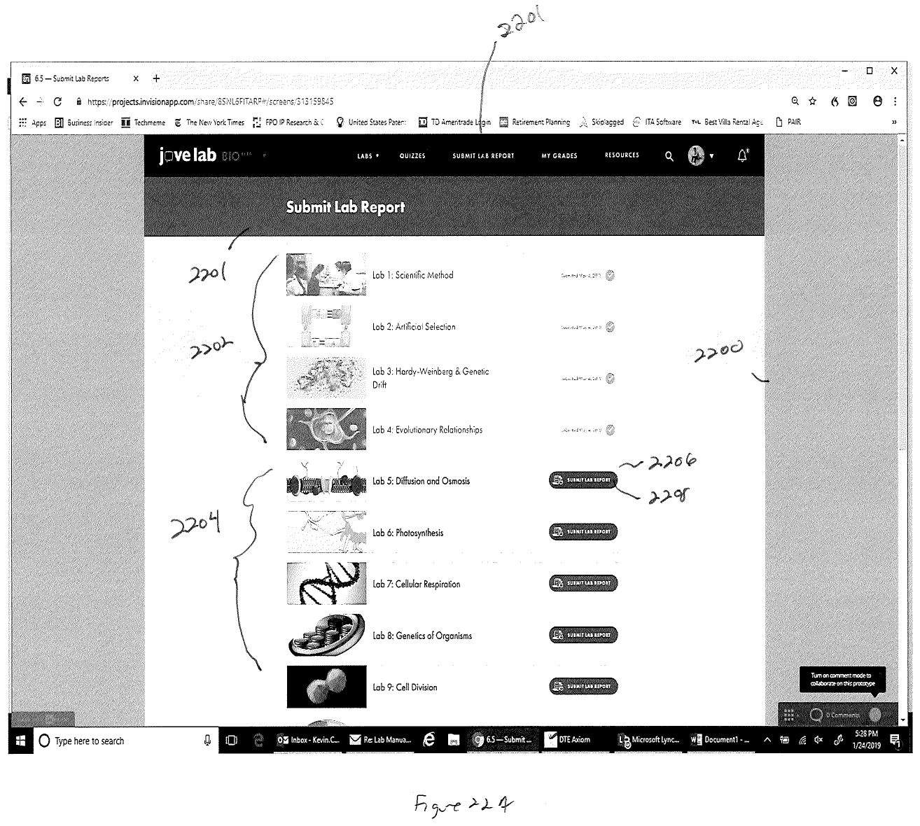

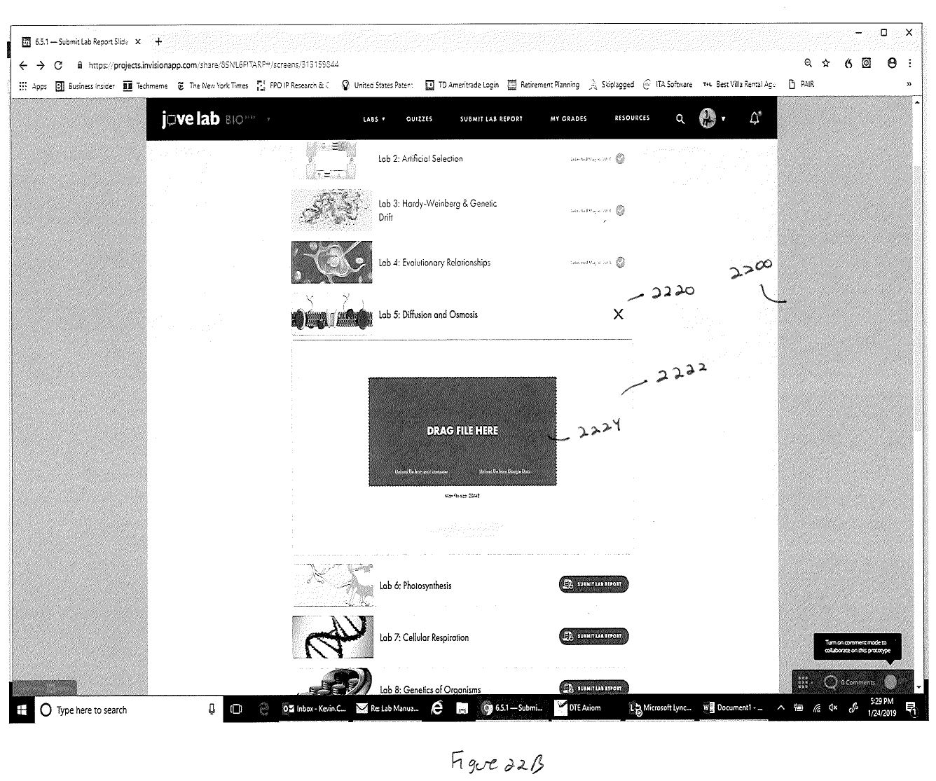

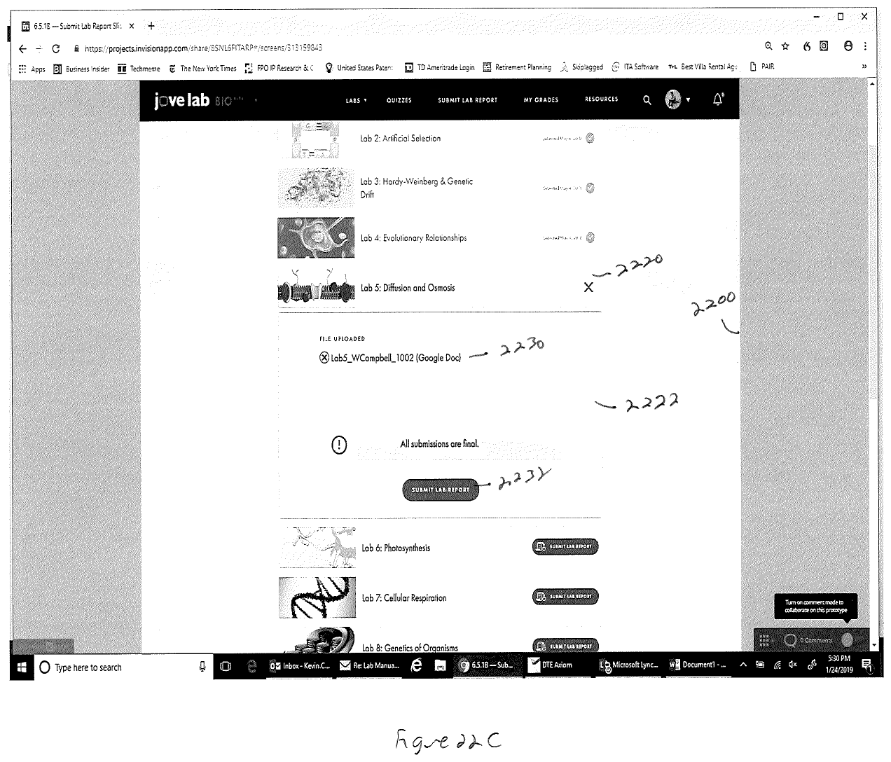

The student may see lab information, such as shown in FIG. 21. This lab information may include a procedure 2102, such as shown in illustrative user interface 2100 in FIG. 21. Notes 2104 may be included as well as the step by step procedure 2106 for completing the lab experiment. The student may submit a lab report, such as by selecting the submit lab report option 2208 shown in FIG. 22A on user interface 2200. The submit lab report header 2201 informs the student that this is the section for submitting lab reports. The completed lab reports 2202 are shown in faded form with checkmarks. The labs 2204 to be completed are not greyed out and do not include a checkmark. Each lab includes an associated user interface element, such as user interface element 2206 for lab five.

A user interface element 2222 (FIG. 22B) may be shown that includes an area 2224 in which the lab report document may be dragged and dropped. Once the lab report document has been dragged and dropped, the user interface element 2222 changes to identify the name of the file 2230 (FIG. 22C) containing the document and a button to submit the lab report to the instructor 2232.

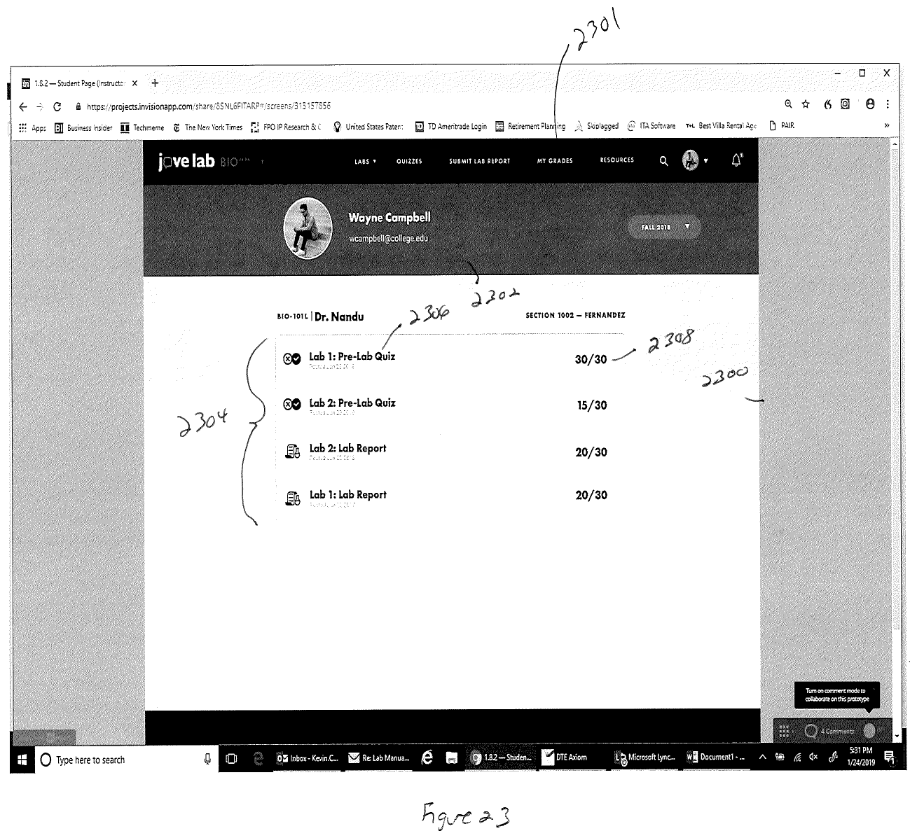

The student may gain access to their grades by selecting the my grades option 2301. As can be seen in FIG. 23, the illustrative user interface 2300 displays a list of grades 2304 for quizzes and lab reports. Each entry may include a name 2306 and a grade 2308. The header 2302 identifies the student.

While the present invention has been described with reference to exemplary embodiments herein, those skilled in the art will appreciate the various changes in form and detail may be made without departing from the intended scope of the present invention as defined in the appended claims.

What is claimed as new and desired to be protected by Letters Patent of the United States is:

1. A method performed by a processor of a computing device, comprising:
transmitting a user interface element for display as part of a user interface for a video lab book, wherein the user interface element is for modifying a lab of the video lab book;
receiving an indication that the user interface element has been activated and receiving at least one modification to the lab;
updating the lab to include the modification; and
transmitting information regarding the updated lab for display.

2. The method of claim 1, wherein the modification is to add or delete a step from a lab procedure for the lab.

3. The method of claim 2, further comprising responsive to activation of the user interface element, transmitting an additional user interface element for adding the step or deleting the step from the lab procedure.

4. The method of claim 1, wherein the modification is to modify a step of a lab procedure.

5. The method of claim 4, further comprising responsive to activation of the user interface element transmitting an additional user interface element for modifying the step of the lab procedure.

6. The method of claim 1, wherein the modification is one of modifying material used in the lab or modifying an amount of a material used in the lab.

7. The method of claim 6, further comprising responsive to activation of the user interface element, transmitting another user interface element for modifying the material used in the lab or modifying the amount of the material used in the lab.

8. The method of claim 1, wherein the modification is adding, deleting and/or modifying notes regarding the lab.

9. The method of claim 8, further comprising responsive to activation of the user interface element, transmitting another user interface element for adding, deleting and/or modifying the notes regarding the lab.

10. The method of claim 1, wherein the method is performed by a server and wherein the transmitting of the user interface element and the transmitting of the information is to a client.

11. A non-transitory computer-readable storage medium storing instructions that when executed by a processor of a computing device perform the following:
transmitting a user interface element for display as part of a user interface for a video lab book, wherein the user interface element is for modifying a lab of the video lab book;
receiving an indication that the user interface element has been activated and receiving at least one modification to the lab;
updating the lab to include the modification; and
transmitting information regarding the updated lab for display.

12. A non-transitory computer-readable storage medium of claim 11, wherein the modification is to add or delete a step from a lab procedure for the lab.

13. The non-transitory computer-readable storage medium of claim 12, further storing instructions for: responsive to activation of the user interface element, transmitting an additional user interface element for adding the step or removing the step from the lab procedure.

14. the non-transitory computer-readable storage medium of claim 11, wherein the modification is to modify a step of a lab procedure.

15. The non-transitory computer-readable storage medium of claim 14, further storing instructions for further comprising responsive to activation of the user interface element, transmitting an additional user interface element for modifying the step of the lab procedure.

16. The non-transitory computer-readable storage medium of claim 11, wherein the modification is one of modifying material used in the lab or modifying an amount of a material used in the lab.

17. The non-transitory computer-readable storage medium of claim 16, further storing instructions for responsive to activation of the user interface, transmitting another user interface element for modifying the material used in the lab or modifying the amount of the material used in the lab.

18. The non-transitory computer-readable storage medium of claim 11, wherein the modification is adding, deleting and/or modifying notes regarding the lab.

19. The non-transitory computer-readable storage medium of claim 18, further storing instructions for responsive to activation of the user interface element, transmitting another user interface element for adding, deleting and/or modifying the notes regarding the lab.

20. The non-transitory computer-readable storage medium of claim 11 wherein the method is performed by a server and wherein the transmitting of the user interface element and the transmitting of the information is to a client.

21. A method performed by a processor of a computing device, comprising:
in a video lab book environment, receiving a lab report;
analyzing the lab report to identify any possible instances of plagiarism; and
if the analyzing indicates that there is at least one possible instance of plagiarism, outputting information indicating that is at least one possible instance of plagiarism.

22. The method of claim 21, wherein the analyzing comprises comparing content in the lab report to the other sources to identify any possible plagiarized portion of the lab report.

23. The method of claim 22, further comprising generating output that identifies the possible plagiarized portion of the lab report.

24. The method of claim 21, further comprising: if the analysis indicates that there are no identified possible instances of plagiarism in the lab report, generating an output indicating that there are no intended possible instances of plagiarism in the lab report.

25. A non-transitory computer-readable storage medium storing instructions that when executed by a processor of a computing device perform the following:
in a video lab book environment, receiving a lab report;
analyzing the lab report to identify any possible instances of plagiarism; and
if the analyzing indicates that there is at least one possible instance of plagiarism, outputting information indicating that is at least one possible instance of plagiarism.

26. The non-transitory computer-readable storage medium of claim 25, wherein the analyzing comprises comparing content in the lab report to the other sources to identify any possible plagiarized portion of the lab report.

27. The non-transitory computer-readable storage medium of claim 26, further storing instructions for generating output that identifies the possible plagiarized portion of the lab report.

28. The non-transitory computer-readable storage medium of claim 25, further storing instructions for if the analyzing indicates that there are no identified possible instances of plagiarism in the lab report, generating an output indicating that there are no identifies possible instances of plagiarism in the lab report.

29. A method performed by a processor of a computing device, comprising:
transmitting a user interface for a video lab book environment, wherein the user interface enables setting or modification of online rights of instructors for a course in the video lab manual environment;
receiving a setting or a modification of a selected one of the online rights of given one of the instructors of the course, where the setting or modification is received via the user interface; and
responsive for receiving the setting or the modification, updating the selected online right
of the given instructor for the course to reflect the received setting or modification.

30. The method of claim 29, wherein the received setting or modification relates to one of a right to send electronic messages to students, a right to add content for online tests, a right to add lab content online, an online right to add online resources or a right to add an additional instructor.

31. A non-transitory computer-readable storage medium holding instructions that when executed by a processor of a computing device perform the following:
transmitting a user interface for a video lab book environment, wherein the user interface enables setting or modification of online rights of instructors for a course in the video lab manual environment;
receiving a setting or a modification of a selected one of the online rights of a given one of the instructors of the course, wherein the setting of modification is received via the user interface; and
responsive for receiving the setting or the modification, updating the selected online right of the given instructor for the course to reflect the received setting or modification.

32. A non-transitory computer-readable storage medium of claim 31 wherein the received setting or modification relates to one of a right to send electronic messages to students, a right to add content for online tests, a right to add lab content online, an online right to add online resources or a right to add an additional instructor.
